(19) United States
(12) Patent Application Publication
(10) Pub. No.: US 2008/0314835 A1
(43) Pub. Date: Dec. 25, 2008

(54) Chiral separating agents with active support

(76) Inventor: Regina Valluzzi, Medford, MA (US)

Correspondence Address: Mark J. Pandiscio;Pandiscio & Pandiscio, P.C., 470 Totten Pond Road, Waltham, MA, 02451-1914, US

(21) Appl. No.: 12/009,232

(22) Filed: Jan. 16, 2008

Related U.S. Application Data
(60) Provisional application No. 60/880,683, filed on Jan. 16, 2007.

(51) Int. Cl. B01J 20/29; B01D 15/08

(52) U.S. Cl. 210/656; 210/198.2; 210/502.1

(57) ABSTRACT

A chiral stationary phase for use in chromatographic separation comprising a chiral selector compound and a chiral support material, wherein the chiral support material comprises a polymer comprising at least 30% chiral monomer of the same orientation.

### REFERENCE TO PENDING PRIOR PATENT APPLICATION

This patent application claims benefit of pending prior U.S. Provisional Patent Application Ser. No. 60/880,683, filed Jan. 16, 2007 by Regina Valluzzi for CHIRAL SEPARATING AGENTS WITH ACTIVE SUPPORT (Attorneys Docket No. 0291388.00137US1(ENS-17), which patent application is hereby incorporated herein by reference.

### FIELD OF THE INVENTION

This invention relates to separation techniques in general, and more particularly to separation and/or purification techniques of chiral materials.

### BACKGROUND OF THE INVENTION

Chromatography is a powerful technique for separating mixtures. Column chromatography systems have a stationary phase (which can be solid or liquid) and a mobile phase (usually liquid or gas). Column chromatography uses a mobile phase to move a mixture of substances through a stationary phase. The different components of the sample have different affinities for the mobile and stationary phases, and emerge from the stationary phase at different times. The stationary phase and mobile phase are chosen based on the nature of the sample mixture in order to achieve the best possible separation of its components.

The number of theoretical plates, n, in chromatography is a figure of merit describing the quality of separation or number of effective separation stages. The higher the number of theoretical plates, the greater the separation. The term theoretical plates (n) is derived from the statistical formulation of a Gaussian shaped peak and takes into account the adjusted retention time and the peak width. The column efficiency (N) normalizes this value to the length of the column used in the analysis and is calculated by dividing the theoretical plates by the column length.

Chiral molecules have application in a variety of industries, including polymers, specialty chemicals, flavors and fragrances, and pharmaceuticals. Many applications in these industries require the isolation and use of single chiral isomers (enantiomers) of chiral compounds. As a general matter, chiral recognition and selection of enantiomers is more demanding than most other forms of chemical interaction and recognition. Enantiomers are difficult to separate because they are topologically identical and differ only in their three dimensional geometry by the presence of a subtle “mirror image” symmetry. Thus, all aspects of their chemistry and separatory behavior appear identical except in the presence of a chiral environment, probe or ligand. A widely held theory suggests that for a chirally specific ligand or binding interaction, three separate sites of interaction are required per molecule, in order to distinguish the three dimensional nature of the difference between enantiomers. Indeed, most common chiral selector technologies rely on multi-point interactions between an enantiomeric analyte and a chiral ligand, for example.

A common method used to separate and obtain single enantiomers of chiral compounds is chiral chromatography. In chiral chromatography, the solid material (typically 5-10 micron scale beads) is referred to as the “chiral stationary phase”, or CSP. The CSP consists of two parts or distinct components. The first component is the material or chemistry that is used to form a solid or porous bead or particle, suitable for packing into a liquid chromatography (LC), high pressure liquid chromatography (HPLC), or supercritical fluid chromatography (SFC) column. This component is referred to as the support and is typically an achiral oxide or polymer. The second component is the chiral selector, a chiral molecule or polymer that recognizes and selectively interacts with other chiral molecules. The CSP is created by attaching the chiral selector to the achiral support. Typically the support surface has some achiral chemical property such as polarity, acidity, basicity, hydrophobicity, lipophilicity, liphobicity, or other general surface chemistries or combination surface chemistries that are still present to a moderate degree in the CSP due to exposed support surface area. These achiral chemical interactions typically do not assist in chiral separation, and in some cases may even interfere with chiral separation, making methods of development and resolution more difficult for the majority of compounds. A great deal of effort in the chiral separation industry has been directed at blocking out chemical contributions and complications derived from the support materials used in CSPs.

Commercial chiral separation agents are coated or coupled onto beads of a support for use in chromatography. The support material is selected to offer solvent stability, mechanical stability, particle size shape and porosity appropriate for the chromatographic application. Typical supports are ceramic oxides such as silica zirconia and titania, and polymers such as poly(divinyl benzene). In some cases, a particular support is selected for its surface chemistry and ability to attach ligands, complex to a chiral selector, and/or form bonds to a chiral selector or to a ligand bound to a chiral selector. While these supports play a valuable role in delivering the chiral selector in a solid stable format compatible with chromatography, the supports themselves are chirally inert. Thus, the support is simply a static support imparting no chiral properties to the final chiral material, or to the chromatographic chiral stationary phase.

The chiral properties of the CSPs are therefore due to the selector bound to, coated onto, or complexed, to the surface of the solid support. Most of the commercially available CSPs are weakly chirally selective materials. Many commercially available chiral separating agents use polysaccharide-based chiral stationary phases, such as cellulose ester derivatives, cellulose carbamate derivatives and amylose carbamate derivates, which have been coated on a silica support. Other chiral separating agents, such as polymethacrylate derivatives and small chiral molecules coupled by ligands, are also known. Chiral polysaccharide stationary phases are commercially available from Chiral Technologies, Inc. of Exton, Pa., under the trademarks CHIRALPAK® amylosic stationary phase and CHIRALCEL® cellulosic stationary phase. The CHIRALPAK® stationary phases all use silica as a support material and differ only in the chiral selectors bound to the silica particles. Exemplary materials include but are not limited to, CHIRALPAK® AD, where the chiral selector is an amylose derivative in which each glucose monomer carries three 3,5-dimethylphenyl carbamate groups, CHIRALPAK® AS, where the chiral selector is an amylose derivative where each glucose monomer carries three (S)-α-phenethylcarbamate groups, CHIRALCEL® OD, where the chiral selector is a cellulose derivative in which each glucose monomer carries three 3,5-dimethylphenyl carbamate groups, and CHIRALCEL® OJ, where the chiral selector is a cellulose derivative in which each glucose monomer carries three 4-methylbenzoyl groups. Reference may be made to U.S. Pat. Nos. 4,912,205 and 5,434,299 for further details, the disclosures of which are hereby incorporated herein by reference.

The chirally selective materials currently available require thousands, or even hundreds of thousands, of plates (typically N>15,000/column) to effect chromatographic separations over sufficient numbers and types of analytes to make the column widely useful and thus commercially viable. The typical chiral analytical column is 25 cm (250 mm) long with chromatographic media particle sizes of 5-10 microns. While chiral separations of organic molecules are possible on an analytical scale, e.g., milligram to gram scale, only a small portion of these separation protocols can be successfully scaled up to production scale.

A key measure of a chiral separation is the resolution Rₛ, which characterizes the chromatographic distance between the two enantiomer peaks, normalized for peak breadth and retention time. For an analytical separation, an Rₛ of greater than 1.0, signifying baseline resolution is adequate. For scale up preparative separations, the column is typically overloaded and run in a high throughput, rather than an ultrahigh resolution mode. As a rule of thumb, an Rₛ of greater than 2 is necessary for column loading and scale-up to be considered feasible. Depending on how the separation behaves under high column loading, even some separations with an Rₛ of greater than two may not be scaleable. As a result, many analytical methods do not transfer when chemists try to prepare even subgram quantities of chiral molecules using HPLC methods.

### SUMMARY OF THE INVENTION

In one aspect of the invention, a chiral stationary phase capable of high chiral resolution at low plate numbers is provided. The chiral stationary phase provides significantly higher selectivity for chiral enantiomers and demonstrates significantly more chemical generality, e.g., the ability to chirally separate a range of analytes of different molecular structures, than existing chiral materials used in chromatography.

In another aspect, the chiral stationary phase includes a molecular chiral selector compound or ligand associated with a chiral support material, in which the chiral support material includes a polymer comprising at least 30% chiral monomer of the same orientation.

The chiral support material is provided in particulate or solid form and demonstrates chiral selectivity in a chemically unmodified state (e.g., without any additional coating or functionalization chemistry). In one or more embodiments, the chiral support material comprises a polymer with a chiral backbone, a polymer containing chiral side chains or pendant functional groups, or other chiral molecular components used to develop the nanostructure or material morphology features of the support. These molecules can remain embedded within the nanoscale structures defining the morphology of the support material. In one or more embodiments, the chirally active support material is combined with conventional molecular chiral selectors.

The chirally active support material remains chirally selective when functionalized with an arbitrary achiral chemistry, chiral chemistry or known molecular chiral selector ligand. In the case of chiral functionalization on the chirally active support, synergistic selectivity effects may be observed.

In one or more embodiments, the chiral support material is chemically coated or functionalized with an arbitrary achiral chemistry, allowing a range of surface chemistries to be addressed, where the chiral support material is used for chiral selection (e.g., as a chirally active support material) and the chemical modification is used to impart surface chemistry.

In one or more embodiments, the chiral support may be a material comprising a protein derivative. The protein derivative can be a fibrous protein, for example, a naturally occurring protein or synthetic polymer that forms fibers or fibrils.

The molecular chiral selector ligand, which is also referred to below as a molecular chiral selector, is a molecular substance, typically a polymer, that is applied to the surface of a material to modify the chiral selectivity properties of the material. More specifically, the molecular chiral selector ligand has a chemical structure, conformation, and in some cases a folded structure that defines chiral pockets on the size dimension of the target molecules to be separated. In one or more embodiments, the molecular chiral selector ligand may be a chiral polysaccharide derivative. The polysaccharide derivative can be, for example, an alkyl phenylcarbamate or α-phenethylcarbamate, which itself is chiral, or a benzoate group.

In one or more embodiments, the molecular chiral selector ligand is covalently bound to, adsorbed onto, or complexed with, the chiral support material. The adsorption may be through physical, electrostatic means, etc. Complexation may use methodologies such as a salt bridge formation, complexation groups bound to the molecular chiral selector ligand and present on the support material surface, either naturally or added in a chemical process, etc.

In one aspect of the invention, a chiral separation column is packed with a chiral stationary phase comprising a molecular chiral selector ligand that is chemically or physically attached to a chiral support material.

In conventional chiral materials, the support is not chirally active. Chiral chemistry must be added to the surface of a conventional passive support to make a chirally active material. Conventional chiral materials attach chiral chemistry, generally molecular chiral selector ligands, to the surface of a chirally inactive support material after the support material has been obtained in a desired format (e.g., as beads or particles). If achiral chemistry is added to a conventional support material, the resulting material is not chiral. If achiral chemistry is added to a conventional chiral material (i.e., support plus molecular chiral selector), it often interferes with the conventional mechanisms for chiral selection, degrading the performance of the chiral material in chiral separations—except in a very small number of non-arbitrary cases where the additional chemistry works with the conventional chiral selector. These infrequent exceptions are well known to those skilled in the art.

The chiral stationary phases according to one or more embodiments of the present invention provide added chiral separation capabilities over the conventional chiral separating materials.

In one preferred form of the present invention, there is provided a chiral stationary phase for use in chromatographic separation, comprising:

a chiral selector compound; and

a chiral support material, wherein the chiral support material comprises a polymer comprising at least 30% chiral monomer of the same orientation.

In another preferred form of the present invention, there is provided a separations column utilizing a chiral stationary phase comprising:

a chiral selector compound; and

a chiral support material, wherein the chiral support material comprises a polymer comprising at least 30% chiral monomer of the same chiral handedness.

In another preferred form of the present invention, there is provided a method of separating a sample containing a plurality of analytes, comprising:

providing a column packed with a chiral stationary phase comprising a chiral selector compound and a chiral support material, wherein the chiral support material comprises a polymer comprising at least 30% chiral monomer of the same orientation, and further wherein the chiral support material preferentially excludes one of a levorotary or dextrorotary compound from the stationary phase;

eluting the column with a first elutent to selectively elution analyte molecules of the excluded orientation, such that the excluded analyte molecules are separated and resolved based on molecular differences; and

eluting the column with a second elutent to elute the remaining analyte molecules of the opposite orientation, such that the remaining analyte molecules are separated and resolved based on molecular differences.

In another preferred form of the present invention, there is provided a chiral stationary phase for use in chromatographic separation, comprising:

a chiral support material comprising chiral nanostructure or materials morphologies imparting chiral selectivity to the support; and

an achiral coating.

In another preferred form of the present invention, there is provided a chiral stationary phase for use in chromatographic separation, comprising:

a chiral selector comprised of a material with a chiral nanostructure; and

a chiral support comprised of the identical material.

In another preferred form of the present invention, there is provided a chiral stationary phase for use in chromatographic separation, comprising:

a chiral support material, wherein the chiral support material comprises a polymer comprising at least 30% chiral monomer of the same orientation;

a chiral nanostructure or morphology within the chiral support material that provides chiral selectivity; and

an achiral coating applied to the surfaces of the support material to modify the chromatographic properties of the support material.

In another preferred form of the present invention, there is provided a separations column utilizing a chiral stationary phase comprising:

a chiral support material wherein the chiral support material comprises a polymer comprising at least 30% chiral monomer of the same orientation;

a chirally selective nanostructure, microstructure or morphology within the chiral material and comprising the material; and

an achiral coating applied to the surface of the material to modify the materials chromatographic properties.

In another preferred form of the present invention, there is provided a chiral stationary phase for use in chromatographic separation, comprising:

a chiral selector comprising a material with a chiral nanostructure;

a chiral comprising the identical material; and

an achiral coating used to modify the achiral chromatographic properties of the material.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIGS. 1-7 illustrate chemical formulas of common ligands used for surface modification in accordance with the present invention;

FIG. 8 illustrates the chemical formula for Di-O,O′-p-toluoyl tartaric acid (DOOPtaa);

FIG. 9 illustrates the results of a Di-O,O′-p-toluoyl tartaric acid (DOOPtaa) separation on a column containing lightly modified material formed in accordance with the present invention and using aqueous epoxide chemistry;

FIG. 10 illustrates the results of a Di-O,O′-p-toluoyl tartaric acid (DOOPtaa) separation similar to that shown in FIG. 9, except on a heavily modified column formed in accordance with the present invention;

FIG. 11 illustrates the results of an injection of the positive enantiomer of DOOPtaa;

FIG. 12 illustrates the results of an injection of the negative enantiomer of DOOPtaa;

FIG. 13 illustrates thermal gravimetric analysis data for biopolymeric material with no crosslinking or surface modification;

FIG. 14 illustrates thermal gravimetric analysis of lightly crosslinked material using an aqueous epoxy reaction;

FIG. 15 illustrates the chemical formula for the fluoxetine molecule;

FIG. 16 illustrates the results of fluoxetine injected onto a column with a lightly modified surface formed in accordance with the present invention;

FIG. 17 illustrates the results of a fluoxetine injection similar to that shown in FIG. 16, except onto a column with a heavily modified surface formed in accordance with the present invention;

FIG. 18 illustrates the chemical formula for the linalool molecule;

FIG. 19 illustrates the results of linalool injected onto a column containing lightly modified material formed in accordance with the present invention;

FIG. 20 illustrates results of a linalool injection similar to that shown in FIG. 19, except onto a column with a heavily modified material using epoxy chemistry;

FIG. 21 illustrates the results of a linalool injection similar to that shown in FIG. 20, except onto a column with a heavily modified material using silane chemistry;

FIG. 22 illustrates the chemical formula for the sulpiride molecule;

FIG. 23 illustrates the results of sulpiride injected onto a column containing lightly modified material using aqueous epoxy ligands;

FIG. 24 illustrates the results of a sulpiride injection similar to that shown in FIG. 23, except onto a column with a heavily modified material using epoxy ligands dissolved in alcohol;

FIG. 25 illustrates the chemical formula for the verapamil molecule;

FIG. 26 illustrates the results of verapamil injected onto a column containing lightly modified material using aqueous epoxy ligands;

FIG. 27 illustrates the results of a verapamil injection similar to that shown in FIG. 26, except onto a column with a heavily modified material using alcohol solvated epoxy and silane ligands;

FIG. 28 illustrates the chemical formula for the ketorolac molecule;

FIG. 29 illustrates the results of ketorolac injected onto a column containing lightly modified material formed in accordance with the present invention;

FIGS. 30-32 illustrate the chemical formula for the trans stilbeneoxide molecule, the binaphtol molecule and the dorzolomide molecule, respectively;

FIG. 33 illustrates the results of the first enantiomer of dorzolomide, DorzA, under conditions of increasing column loading on a silane C8 and phenylisocyanate modified material column formed in accordance with the present invention; and

FIG. 34 illustrates the results of the second enantiomer of dorzolomide, DorzB, under conditions of increasing column loading on a silane C8 and phenylisocyanate modified material column formed in accordance with the present invention.

### DETAILED DESCRIPTION OF THE PRESENT INVENTION

The present invention provides chiral stationary phase materials which have significantly higher selectivity for chiral enantiomers and significantly more chemical generality than existing chiral materials currently used in chiral chromatography. In these novel materials, high chiral selectivity and high separation capacity coupled with broad chemical generality are effected by the combined synergistic effect of the molecular chiral selector ligand and the chiral support material.

It should be appreciated that the term “chiral support material” is generally referred to herein as a material which cannot be melted, dissolved, or manipulated in ways that would alter its nanoscale structure and porosity without losing the chiral selectivity inside the material. Furthermore, the chemical identity of the chiral support material is largely irrelevant to chiral selectivity, provided that the nanostructure is not altered (e.g., melted, softened, excessively smoothed over, bent, decorated with globules, etc.).

It should also be appreciated that the terms “molecular chiral selector” and “chiral selector” are generally referred to herein as a molecular chiral ligand, or a surface treatment made of molecules, which does not require a specific nanostructure for chiral selectivity, but possesses chiral selectivity and chemical properties derived primarily from its bonded structure (and/or local conformation). Furthermore, the chemical identity of the molecular chiral selector is the primary determinant of the chiral selectivity of the molecular chiral selector. The chiral selectivity of the molecular chiral selector does not depend on material order and will not be disrupted if the molecular chiral selector is dissolved, sprayed, coated, recrystallized, etc, as long as chemical identity is preserved.

The chirality of the molecular chiral selector ligand may be manifested as the surface availability of chiral functional groups from the chemical structure of the molecular chiral selector ligand. In one or more embodiments, the molecular chiral selector ligand is a polysaccharide-based chiral compound. The polysaccharide may be any of the synthetic polysaccharides, natural polysaccharides and/or polysaccharide derivatives, such as a cellulose ester derivative, a cellulose carbamate derivative or an amylose carbamate derivate, etc., provided that it is optically active. For instance, usable polysaccharides include α-1,4-glucan (e.g., amylose), β-1,4-glucan (e.g., cellulose), α-1,6-glucan (e.g., dextran), β-1,6-glucan (e.g., pustulan), α-1,3-glucan, β-1,3-glucan (e.g., curdlan), schizophylan, α-1,2-glucan, β-1,2-glucan, β-1,4-chitosan, β-1,4-N-acetylchitosan (e.g., chitin), β-1,4-galactan, α-1,6-galactan, β-1,2-fructan (e.g., inulin), β-2,6-fructan (e.g., levan), α-1,4-xylan, α-1,4-mannan, α-1,6-mannan, pullulan, agarose, alginic acid, starch having a high amylose content, etc. More preferred are cellulose, amylose, β-1,4-chitosan, chitin, β-1,4-mannan, β-1,4-xylan, inulin and curdlan.

Typical aromatic carbamate or ester derivatives of cellulose or amylase can be generically represented by the formula:

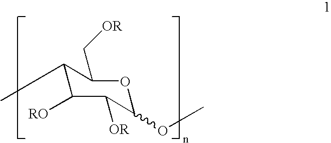

in which the depicted glucosidic linkage is either α (amylose) or β (cellulose) and where n is a degree of polymerization selected for chiral performance and ease of handling. Typically, n is less than 500. The depicted R groups can be, for example, a phenylcarbamate (shown below as 2), an α-phenethylcarbamate (shown below as 3), which itself is chiral, or a benzoate group (shown below as 4).

The phenyl carbamate is generally depicted as:

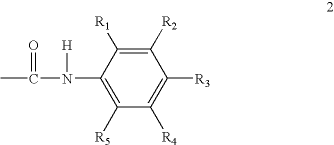

where at least one of R¹ through R⁵ can be a straight chain alkyl group of 1 to 8 carbons or a branched alkyl group alkyl of 3 to 8 carbons.

The α-phenethylcarbamate is generally depicted as:

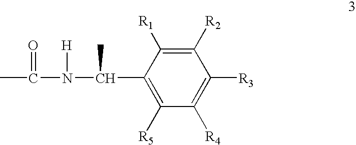

where at least one of R¹ through R⁵ can be a straight chain alkyl group of 1 to 8 carbons or a branched alkyl group alkyl of 3 to 8 carbons.

The benzoate is generally depicted as:

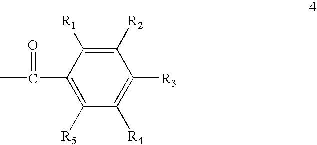

where at least one of R¹ through R⁵ can be a straight chain alkyl group of 1 to 8 carbons or a branched alkyl group alkyl of 3 to 8 carbons.

Thus, typical R groups may include 3,5-dimethylphenyl carbamate, α-phenethylcarbamate, and 4-methylbenzoate. These and other chiral polysaccharide selector molecules are available attached to silica supports, as chiral selection materials, from Chiral Technologies, Inc. of Exton Pa. Further details of these materials and synthetic methods for their preparation are available in U.S. Pat. Nos. 4,861,872 and 5,434,299, which are hereby incorporated herein, in their entirety, by reference.

In one or more embodiments, the chiral support material is a polymer. The polymer should be chiral, e.g., have a net chiral property. Typically, the synthetic polymer contains at least 30% chiral monomers of the same orientation. In certain embodiments it should be appreciated that, the polymer may contain at least about 50%, or at least about 70%, or at least about 90%, chiral monomers of the same orientation.

The chiral nature of the polymer (whether natural or synthetic) plays a role in the molecular configuration, molecular superstructure, and in long-range-ordered and larger elements of structure typically described as the material's morphology, microstructure, or nanostructure. In certain embodiments, the chiral support material is a protein-based chiral support material, however, synthetic polymers may also be used. The chiral support material may have a particle size ranging from 1 μm to 1000 μm, but for specific applications may have a particle size of less than 500 μm, less than 100 μm, less than 50 μm, less than 25 μm, as desired. This is important to note that different particle sizes may be appropriate for different chromatographic applications.

A distinction of the chiral support material formed in accordance with the present invention is its chiral selectivity, i.e., its ability to distinguish between, and preferentially interact with, one of two enantiomers of the same compound. A source fibrous protein, while comprising chiral polymeric molecules, typically demonstrates no chiral selectivity, or is only poorly selective. These and other features in the physical and optical properties of the chiral materials, according to one or more embodiments of the present invention, reflect the changes in the solid-state arrangements of the material. These types of solid state arrangements, and the differences between the arrangements, are referred to in the art as materials morphologies or microstructures. Materials morphologies and microstructures are derived from underlying differences in thermodynamically preferred arrangements of molecules, referred to as materials phases, microphases, or mesophases.

The chirality of the support material may be manifested in a variety of ways, including but not limited to, (i) as the surface availability of chiral functional groups from the chemical structure of the support material, (ii) as chiral molecular scale (e.g., 0.2-2 nm) pockets, grooves, ridges or other textures on the support surface due to the superstructure and conformation of the chiral molecules used to construct the support, (iii) as chirally curved channels within the material larger than the molecular scale (e.g., 2-50 nm in diameter), or (iv) by a chiral pattern in the connectivity between pores in the support material.

In one or more embodiments, the chiral support material forms nanoassemblies that include both chiral surfaces and chiral internal volumes. The chiral support material may form rolled or crumpled sheets and these sheets may be interconnected (although this not necessarily so) and possess a chiral surface texture. A feature of the chiral material in one or more embodiments is an increase in porosity and a decrease in aspect ratio, when compared to the source fibrous polymer. In one or more embodiments, the chiral support material contains a network of pores where the pores are interconnected and the connections are offset in a manner that makes the pore and its connections form a chiral unit. In one or more embodiments, the chiral support material contains a network of interconnected pores, where the connections are offset in a manner that results in a tortuous path through the material. It should be appreciated that each tortuous path is biased in favor of a particular set of twists, tilts and turns comprising the offsets, making each path chiral, and wherein more than about 50% of the tortuous paths through the material share the same chiral bias.

Exemplary naturally fibrous proteins used for the chiral support material include one or more bioproteins such as silk, collagens, keratins, seroins or chorions. Suitable sources for natural proteins include protein originates from species in the following families genera or orders: Bombyx, Antherea, Gonometa, Borocera, Anaphe, Argemia, Argiope, Tetragnatha, Gasteracantha, Araenea, Nephila, Embiidina, Hymenoptera. Further non-limiting examples of silk-producing genera, families, and specific organisms include the following Tetragnathidae, Agelenidae, Pholcidae, Theridiidae, Deinopidae, Meteorinae (Hymenoptera, Braconidae), Embiidina, Tropical Tarsar Silkworm Anthereae, Eri Silkworm, Samia recini, Philosamia ricini, Antheraea assama, Nang-Lai, Saturniidae, Antheraea periya, B. mandarina, Antheraea mylitta (Doory), Antheraea Asamensis Helfer, cocoons of the parasitic wasp Cotesia (Apanteles) glomerata, Antheraea yamamai, Callosamia (Saturniidae), Hemileuca grotei (Saturniidae), Anisota (Saturniidae), Schinia, Hemileuca (Lepidoptera, Saturniidae), genera Actias, Citheronia (Saturniidae) and subfamily Euteliinae (Noctuidae), Hemileuca maia complex (Saturniidae), Arsenurinae (Saturniidae), Agapema (Lepidoptera, Saturniidae), Attacus mcmulleni (Saturniidae), Lasiocampidae (Lepidoptera), Attacus Caesar, Anisota leucostygma, Cricula trifenestrata, Natronomonas pharaonis, Sphingicampa Montana, Pygarctia roseicapitis, Leucanopsis lurida, Hemileuca hualapai, Hemihyalea edwardsi, Grammia geneura, Eupackardia calleta (wild silkmoth), Automeris patagoniensis, Automeris cecrops pamina, and Antherea oculea.

For clarity, the present invention is described with reference to fibrous proteins, and specifically with reference to silk-based proteins. However, the methods and compositions described herein are not intended to be so limited and may be used with other fibrous proteins or synthetic polymers, as is apparent to those of skill in the art.

The chiral selector and the chiral support material are linked to provide a multiphase chiral stationary phase. In one form of the present invention, the chiral selector may be physically adsorbed onto an available surface of the chiral support material. For example, the chirally selective materials (i.e., the chiral selector and the chiral support material) may be mixed as powders for use as a chiral sorbent. The smaller molecular chiral selector ligands can then be adsorbed onto the surface and the internal volumes of the chiral supporting material. Adsorption may be effected through physical and/or electrostatic means. In addition, the chiral selector may be linked to the chiral supporting material through a salt bridge formation, complexation groups bound to the selector and present on the support (either naturally or added in a chemical process), etc.

In one or more embodiments, the chiral selector molecule and the chiral support material may be chemically linked or coupled to one another. In one or more embodiments, the two chiral separation materials may be covalently linked to one another. In this respect, the chiral selector and the chiral support material may be directly linked through reactive moieties on the respective components, or they may be linked through a spacer that bridges the chiral selector and the chiral support material. In one or more embodiments, the spacer may comprise a bifunctional moiety.

In one or more embodiments, the amount of chiral selector molecule may be selected to cover substantially all of the available surface of the chiral support material. The amount of the molecular chiral selector molecules may be sufficient to be adsorbed, or linked to, substantially all of the available surface area and some, or all, of the accessible internal volumes of the chiral supporting material. The term “accessible internal volume” is meant to refer to the internal spaces that have connectivity to the exterior of the particle and that are of sufficient volume to permit movement of analyte molecules through the volume of the chiral support materials. When the molecular chiral selector covers substantially all the available surface of the chiral support, the contribution of the chiral support material may be minimized.

In other embodiments, the amount of the molecular chiral selector may be less than sufficient to substantially cover all of the available surface area of the chiral support material. In this case, the amount of molecular chiral selector may be selected so that a portion of the chiral support material is accessible to interact with the analyte. In one or more embodiments, a portion of the chiral support material is chemically coated or functionalized with an arbitrary achiral chemistry, allowing a range of surface chemistries to be addressed. As is discussed in greater detail below, the accessible surfaces and internal volumes of the chiral support material may provide additional, synergistic chiral separation performance.

In one or more embodiments, about 0.7 mg to 2.0 mg of chiral selector molecule per 1 g of chirally active support may be used. The precise amounts will depend on the shape, molecular weight, rigidity and attachment site of the chiral selector.

When the novel chiral support materials of the present invention are formatted into particles appropriate for chiral HPLC column packing, they retain their high selectivity and capacity in both a static sorbent mode and as chiral HPLC media packed into a column and used chromatographically. See, for example, co-pending U.S. patent application Ser. No. 11/641,257, filed Dec. 19, 2006, entitled “Particulate Chiral Separation Material”, co-pending U.S. patent application Ser. No. 11/641,344, filed Dec. 19, 2006, entitled “Production Of Chiral Materials Using Crystallization Inhibitors” and co-pending U.S. Provisional Patent Application Ser. No. 60/843,276, filed Sep. 8, 2006, entitled “Solid Phase Extraction Devices for Chiral Separation”, which are hereby incorporated herein, in their entirety, by reference.

A method of preparing the novel compositions of the present invention is now described.

Polysaccharides of suitable formula and molecular weight are generally commercially available. For example, chiral polysaccharide separation materials are available from Chiral Technologies, Inc. of Exton Pa. Regis Technologies, Inc. of Morton Grove, Ill., Advanced Separations Technologies, Inc. (Astec) of Bellefonte, Pa. and Eka Chemicals of Sweden also provide chiral selector materials that may be used in accordance with the present invention.

Particles of the protein-based, chirally active support material may be prepared by heat annealing a fibrous protein in an aqueous solution containing a swelling agent. It should be noted that protein load is not critical. Swelling of the natural fiber allows for rearrangement of the molecules in the fibrous protein nanostructure, which in many cases may already be in a molecular arrangement that is close to the desired structure for chirally selective materials. The fibrous polymer forms a well-ordered molecular structure and aligns well with its neighbors in order to produce a stable material. Because the natural fiber polymer/protein is simply swollen in the aqueous solution, the original protein configuration is not lost, as would be the case if the protein is instead fully dissolved. At this point, only minor rearrangement of the polymer molecules is required to achieve a desired configuration. The aqueous solution is heated above ambient temperature, but below the critical temperature at which the protein would be denatured. Or, in the case of a polymer, the solution is heated until it reaches the glass transition temperature, or melting temperature. Typical anneal temperatures for fibrous proteins range from about 90-95° C. By choosing the appropriate annealing temperature and swelling agent, the ordered domains in the protein fiber can be readily driven into the desired chiral structure required for chiral separating materials. Annealing is conducted for a time sufficient to adequately swell the protein structure to disrupt the existing molecular configuration (e.g., crystalline β-sheets), so that rearrangement can occur. Exemplary annealing times range from about one hour to 24 hours, and are preferably about 4 or more hours.

By heating the swollen polymer as described above, the desired configuration is formed, and upon cooling, the polymer becomes locked into that configuration. Particles are typically formed from this cooling process. The chiral material is provided as uniform rounded particles of a fibrous polymer, e.g., a protein or synthetic polymer that forms fibers or fibrils. A fibrous protein or polymer comprises a molecule that naturally assumes an aspected structure, e.g., a structure having an aspect ratio of greater than about 3. The particles may have a variety of shapes, including but not limited to, elongated or needle-shaped particles, spheroidal particles, toroidal or lobed particles, square or trapezoidal particles, etc. In accordance with the present invention, the aspect ratio is less than that of the source fibrous protein and is preferably about 2:1 to 1:1.

Without being bound by any particular mode of operation, it is believed that rounded, or other low aspect polymer shapes, form upon cooling. These rounded particles are formed instead of fibrils, which are more consistent with the source material, because the polymer seeks to avoid the loss of ordered nanodomains that can arise over long distances. Formation of rounded particles naturally limits the nanodomains and retains the desired chiral nanostructure. The low aspect particles resulting from the manufacturing process exhibit good flow and packing properties, making them well-suited for chromatography applications.

Chiral materials may also be prepared by processing the precursor polymer material in solution and then solidifying the polymer material to impart sufficient chiral pores having a chiral volume in the solidified form. In one or more embodiments, a sol is generated from the prepared raw material. The sol may be obtained, for example, by cooling a polymer solution from an elevated temperature to a lower temperature. The polymer may be dissolved in a salt solution to form the gel, or may be dissolved in a solvent or solvent system strong enough to maintain separation and distinctness between the polymeric molecules in solution, but not so strong so that secondary and supersecondary structures are lost. The viscous sol obtained may optionally be dialyzed to remove the salts used in sol formation. The sol is then allowed to gel, thereby adopting the internal chiral volumes that are used in chiral separation. When dried, the dried gel retains the chiral nanomorphology. The dried gel can then be ground into particles of suitable size and shape for use as a chiral support material.

Selection of the appropriate chiral protein starting material can provide preferential chiral selection of levo(−)- or dextro(+)-rotary enantiomers. If a chiral molecule rotates light to the right (i.e., clockwise), the optical rotation is given a (+) sign and the sample is considered dextrorotary. If rotation occurs to the left (i.e., counter-clockwise), the optical rotation is assigned a (−) sign and the sample is considered levorotary. For example, chiral materials derived from the silk-based proteins of the Bombyx silk family preferentially retain and interact with levorotary compounds such as the (+) isomer of lysine, L-lysine.

Further information regarding suitable chiral particulate material is found in co-pending U.S. patent application Ser. No. 11/641,257, filed Dec. 19, 2006, and entitled “Particulate Chiral Separation Material”, and in co-pending U.S. patent application Ser. No. 11/641,344, filed Dec. 19, 2006, and entitled “Production Of Chiral Materials Using Crystallization Inhibitors”, the entire contents of which are hereby incorporated herein by reference. Chiral support material is also commercially available from ENS, Inc. of Cambridge Mass.

Linking of the polysaccharides molecular chiral selector with the protein chiral support material may be accomplished in a variety of ways. For example, the particles of each of the two materials may be mixed together, e.g., by grinding or ball mixing, so that the smaller molecular chiral selector particles adhere to both the outer surface and accessible inner volumes of the chiral support material.

In one or more embodiments, the molecular chiral selector may be linked to the chiral support material by reacting reactive hydroxyl groups of the polysaccharide molecular chiral selector directly with reactive groups of the chiral support material. In the case of a protein-based chiral support material, amino, sulfhydryl, hydroxyl and organic acid groups are available as potential reaction sites. One or more of the reactive sites on the polysaccharide or the protein-based chiral support may be derivatized with protecting groups, or activating groups, as is well known in the art.

In one or more embodiments, the chiral selector may be linked with the chiral support material through a spacer or a linking moiety. Spacers are capable of bonding to both the chiral support material and a polysaccharide, and may have the same, or different, two or more functional groups in which one functional group chemically bonds to a site on the polysaccharide while the other functional group chemically bonds to a site on the chiral support material. Exemplary functional groups, for example, include a vinyl group, an amino group, a hydroxyl group, a carboxyl group, an aldehyde group, an isocyanate group, a thiocyanate group, an isothiocyanate group, a thiol group, a silanol group, an epoxy group, an ether group, an ester group, an amido group, a halogen atom, etc.

For protein-based chiral materials, reactive groups include OH, SH, NH₂ and COOH. In one or more embodiments, a spacer includes bi- or poly-functional isothiocyanates, acids, amines, epoxides, and the like. In one exemplary embodiment, the epoxide is capable of reacting with the hydroxyl moieties of the polysaccharide as well as hydroxyl moieties of the protein. Epoxy-modified polysaccharides are widely used in a variety of commercial applications and may be modified for use in the coupling to the chiral protein materials described herein. These groups allow for coupling with the polysaccharide materials and include formation of glycidyl ethers. For condensation, di-acids, di-amines, amino alcohols, di-ols, mixtures of the two functional groups, and anhydrides are all possible linking agents. However, linking is not limited to di-functional groups, and tri- and tetra-functional crosslinking agents can be used as well.

In other embodiments, a complex or association may be formed between the chiral selector and the chiral support material. One or both of the components can be treated with complexing or ionic groups for generation of a complexing or salt bridge association between the components. Alternatively, complex associations may form between groups naturally found in one or both of the components.

The chiral materials described herein provide significantly higher selectivity for chiral enantiomers and significantly more chemical generality than existing chiral materials used in chromatography. The polysaccharide-based chiral separating agent and the protein-based separation material have the ability to optically resolve chiral molecules when used alone. For example, chirally selective materials based on chirally active supports have a high chiral selectivity and high loading capacity when used alone as a single chiral separating agent. Enantiomeric excesses of greater than 20%, 30%, 40% and 50% have been observed in a single step (e.g., in a single step of solid phase extraction). In contrast, polysaccharide-based chiral separating agents bound to chirally inactive supports, such as silica and titania, typically achieve <1-5% per separation step, and require column formats with hundreds or thousands of equivalent steps to achieve a high enantiomeric excess.

While each of these materials is effective to separate various optically active materials, they operate on different principles. For example, the protein-based chiral material provides a uniquely shape-based chiral separation agent, which biases transport and solubility within the materials in an enantio-specific manner. While not being bound by any particular mode or theory of operation, the materials contain a network of small diameter, chirally curved channels that provide a chiral environment small enough for molecules to “see” the chirality of the container as a significant feature of the environment, yet large enough to avoid significantly hindering molecular transport and diffusion through the material. This provides high capacity chiral separation of a general chemical specificity. In contrast, the saccharide-based chiral separation agent presents a chiral surface on the size scale of the molecule to be separated. Selectivity arises from the preferential interaction of one enantiomer with the chiral selector at multiple points in the molecule (so-called “three-points interaction” theory). This provides highly selective chiral separations, albeit at the expense of separation capacity.

It is believed that a separations system that employs both a protein-based chiral separation agent and a saccharide-based separating agent will achieve an improvement in separation over either method separately. The different operating mechanisms of the two separating materials complement each other and provide a powerful and effective system for separating racemic mixtures. Because of the high capacity of the protein-based separations materials, separations protocols of the present invention can be successfully scaled up to production scale. Furthermore, the polysaccharide molecular chiral selector systems are familiar to those skilled in the art and the separations conditions suitable for the resolution of various compounds are understood by those skilled in the art. Using a molecular chiral selector layer as an interface with the analyte therefore enables users to employ methods and conditions that are understood by those skilled in the art for the molecular chiral selectors, while taking advantage of the greater capacity and chiral selectivity of the chiral support material.

Particle size of the chiral stationary phase according to one or more of the embodiments described herein may be selected for a particular separations application, for example, supercritical fluid separations, low to moderate pressure (e.g., about 100 psi to about 200 psi) liquid chromatography (LC), flash LC, affinity LC, and HPLC. The chiral material includes a particle having a particle size of less than 25 μm, and preferably in the range of about 10-25 μm. In some instances, supercritical fluid applications may use chiral sorbent having a particle size between about 1-10 microns. HPLC applications may use chiral sorbent having a particle size between about 5-25 microns and low pressure LC applications may use chiral sorbent having a particle size between about 10-150 microns. Columns having dimensions of 4.5 mm (inner diameter)×50 mm (length), 4.5 mm×30 mm, and shorter lengths can be packed and used to achieve baseline separations with high resolution on a wide variety of compounds typically found as chiral chromatographic analytes, as well as producing baseline separations on analytes where chiral HPLC is enabled by these materials. Shorter columns, e.g., less than 3 cm, may be particularly suited for methods development. The shorter columns result in faster run times and more rapid methods development.

The selectivity and capacity of the chiral stationary phase, according to one or more embodiments described herein, enables novel HPLC column formats. The stationary phase may be conveniently packed in columns adapted for use with commercially available HPLC systems. A simulated moving bed apparatus can also be employed.

In certain embodiments, the chiral stationary phase according to one or more embodiments described provides chiral selectivity sufficient for analytical chromatography and quality control applications. For example, in some embodiments, scaled up separation is achieved in about 10 to about 20 sorbent stages of LC. In some instances, the chromatography columns are operated in isocratic, gradient, reverse phase, or ion-affinity mode. The columns are suitable for use with aqueous and non-aqueous solvents.

In one or more embodiments, the chromatographic systems are adjustable to cause either enantiomer of a chiral compound to elute first, depending on the nature of the chiral stationary phase and/or the solvent system used as a mobile phase in the separation. Solvents that swell the chiral support material tend to reverse the elution order as opposed to solvents that do not swell the material. While not bound by a particular mode of operation, this observation suggests that a change in the chiral shape of the chiral support material nanochannels alters the chiral retention behavior. Another possible mechanism is a more complex interplay between physical shape based selection and chemical complexation interactions. Strong polar and electrostatic chemical interactions are effectively screened in non-swelling solvents, allowing the shape interaction to dominate chiral selectivity, whereas shape interaction is weakened in swelling solvents, where polar, electrostatic and H-bonding interactions are stronger and dominate. Solvent-based elution order reversal is possible because of the generality of the chiral selection mechanism(s) provided by the chiral support material. Since chiral separation can be obtained across a range of solvents and solvent systems, varying the solvent composition provides a rich landscape of chirally selective behaviors.

In addition to standard chiral separations, the systems are suitable for carrying out chemical separations, separation of achiral stereoisomers, and multi-component separations, including simultaneous resolution of multiple chiral isomers and their enantiomers and/or achiral stereoisomers and/or chemically closely related species.

In certain embodiments, the columns are used to simultaneously separate several different compounds, each of which is present as a mixture of isomers. Each enantiomer and/or stereoisomer of each compound elutes separately.

In one embodiment, the isomers of one compound elute separately, followed by separate elution of the isomers of another compound.

In other embodiments, initial separation of, for example, dextrorotary enantiomers (or levorotary, if desired) may occur first, due to preferential exclusion of (+) chiral orientation from the chiral support material. Of the two excluded (+) enantiomers, interactions with the molecular chiral selector results in their resolution from one another. Following elution and resolution of the (+) enantiomers, the solvent system can be changed to elute and resolve the (−) enantiomers. Chromatographic separations using the chirally selective materials made as described in one or more of the embodiments herein generally are performed with an analyte on the gram or milligram scale.

The solvent system for chromatography applications is chosen based on the analyte according to standard methods known to those skilled in the art. In some instances, larger particles (e.g., about 150 μm or less) are used in aqueous media. In certain embodiments, for columns to be used with aqueous solvents, the particles of chirally selective medium are pre-swollen in water prior to packing. In some instances, the material is cross linked prior to packing to provide limited water stability. In some instances, the material is coated with a hydrophobic layer (e.g., silage coupling agents such as hexamethylsilane (HMDS)) to provide stability against swelling by water and to promote hydrophobic reverse phase interactions. Treating the material to stabilize it against swelling by water allows for the use of up to about 10% water as an additive in HPLC analyses and purifications.

In some embodiments, an HPLC column is packed with particles of chiral stationary phase according to one or more embodiments described that are between about 5 μm and about 25 μm, or particles that are about 25 μm or smaller (no fine particle cut-off), or particles that are between about 25 μm and about 100 μm. By way of example but not limitation, in certain embodiments, a column is packed as follows. The chiral stationary phase according to one or more of the embodiments described herein can be slurried using isopropanol and/or hexane. The slurry can be pumped into a column, or into a pre-column reservoir, which can then be connected to an empty column casing. In some embodiments, the column is between about 1.0 cm and about 5 cm long, or about 3 cm and about 5 cm long, and between about 0.5 mm and about 2 cm in inner diameter. Once the column is full, the column can be sealed for use, e.g., in normal phase HPLC. In certain embodiments, chiral stationary phases according to one or more embodiments described herein from used columns can be regenerated by swelling, washing and then de-swelling the columns for re-use.

HPLC columns made from chiral stationary phases according to one or more embodiments disclosed herein provide excellent selectivity, purity, yield and throughput. The columns allow for separation of enantiomers and achiral stereoisomers of classes of compounds including but not limited to, terpenes, free amines, free acids, alkaloids, chiral acids, chiral bases, organometallics, inorganic compounds, etc.

Chiral HPLC columns made with media as described in one or more of the embodiments disclosed herein provide improved capacity per unit length as compared to currently available HPLC columns. HPLC columns packed with currently available chiral media or stationary phases generally do not have a high capacity per run, e.g., typically less than about 2-4 μg of analyte/cm column length can be injected onto a column before significant degradation of peak shape and column resolution occurs. Due to the limited selectivity and capacity of currently available chiral HPLC columns, large numbers of HPLC runs typically are required for gram scale purifications. The HPLC and SFC columns prepared in accordance with one or more embodiments of the invention are expected to provide significantly increased capacity per unit length for a wide variety of molecules.

The present invention is described with reference to the following examples, which are provided for the purpose of illustration only and are not intended to be limiting of the invention.

### EXAMPLES

### Example 1

### Process of Making a Chirally Selective Powder from Silk Fibers Derived from Bombyx Genus Silk Sources

Sericin-free silk from Bombyx silk can be obtained using conventional methods, such as, heating at 100° C. in 0.2M Na₂CO₃. Sericin-free silk fibers (67 g) were combined with 40.2 mL of 5N HCl and 67 g of NaCl into 1340 mL of tap water. The mixture was heated to roughly 80° C. during mixing and then the temperature was held at 90° C.-95° C. The fibers sat on the surface of the solution, then started to wet. As the fibers wet, they began to sink, and stirring was started at this point. The mixture was stirred at high speed for one hour. After one hour the mixture was cooled to room temperature.

The cooled mixture was first filtered through a 1000 μm sieve to remove the large particulates and then filtered through a 150 μm sieve to separate smaller particles of dirt from the protein particles. The swelling solution was neutralized with 10% Na₂CO₃ solution until the pH reached 6-7, and then the particles were washed with water. In this procedure, 1 g silk protein was washed with 25 mL of water. This mixture was stirred at room temperature for 5 minutes, filtered, and then a change of the washing water was added with more stirring. The steps of stirring, filtering and washing were repeated three times until the conductivity of the water fell to 600 mHo and stabilized (because the conductivity of tap water is around 600 mHo), and then continued for a further three wash cycles using DI water (at the same ratio of silk to tap water). Washing continued to ensure that the conductivity of the wash water was approximately the same after washing as the as-received DI water (around 25-50 mHo) (typically three wash cycles). A final washing step used 2-propanol.

To dry the chiral material, the material was filtered, placed into reusable dishes, dried at room temperature over night, and then dried in a vacuum oven for one hour at 55° C. The material cooled down in a dessicator at room temperature overnight. The material was then sieved to sort the particles.

### Example 2

### Process to Make a Chirally Selective Powder from Silk Fibers Derived from Antheraea Genus Silk Sources

Sericin-free silk fibers from Antheraea silk were obtained using conventional methods, e.g. heating at 100° C. in 0.2M Na₂CO₃. Sericin-free silk (67 g) was combined with 40.2 mL of 5N HCl and 67 g of NaCl into 670 mL of tap water at 80° C. The temperature was held at 90° C.-95° C. The fibers sat on the surface of the solution, then started to wet. As the fibers wet, they began to sink, and stirring was started at this point. The mixture was stirred at high speed for one hour. After one hour the mixture was cooled to room temperature.

The cooled mixture was first filtered through a 1000 μm sieve to remove the large particulates and then filtered through a 150 μm sieve to separate smaller particles of dirt from the protein particles. The swelling solution was neutralized with 10% Na₂CO₃ solution until the pH reached 6-7, and then the particles were washed with water. In this procedure, 1 g of silk protein was washed with 25 mL of water. This mixture was stirred at room temperature for 5 minutes, filtered, and then a change of the washing water was added with more stirring. The steps of stirring, filtering and washing were repeated three times until the conductivity of the water fell to 600 mHo and stabilized (because the conductivity of tap water is around 600 mHo), and then continued for a further three wash cycles using DI water (at the same ratio of silk to tap water). Washing continued to ensure that the conductivity of the wash water was approximately the same after washing as the as-received DI water (around 25-50 mHo) (typically three wash cycles). A final washing step used 2-propanol, a chiral solvent.

To dry the chiral material, the material was filtered, placed into reusable dishes, dried at room temperature over night, and then dried in a vacuum oven for one hour at 55° C. The material cooled down in a dessicator at room temperature overnight. The material was then sieved to sort the particles.

### Example 3

### Preparation of Protein-Based Chiral Material

Washing raw material to remove sericin. 3500 mL of tap water with 0.022 M Na₂CO₃ and 8 g of sodium dodecyl sulfate was heated until boiling. 100 g of silkworm cocoons were added, and the base solution temperature was controlled between 95° C. and 100° C. for 45 minutes. Using tap water, sericin was washed from the silkworm cocoons until the pH was 7. The sericin-free silkworm cocoons were dried by spinning and placed in a hood at room temperature. After two days, the dried sericin-free silk was removed from the hood. The weight of silk recovered was about 70% to 73%.

Sol generation. 350 mL of 9.3 M LiBr solution was heated to about 65° C. to 75° C. Silk recovered from washing in the previous step was added slowly, for a total time of about 1 hour, until all of the silk was dissolved. Solutions were prepared with between 10% and 40% silk by weight. This concentration decreased during processing, especially at the dialysis step. The temperature was not allowed to exceed 75° C., and reaction time was limited to one hour, so that the sol would not be too deep in color. The solution was cooled down to room temperature, forming a viscous sol.

Dialysis. The viscous sol formed in the previous step was placed in dialysis tubing (3500 MWCO). The sol was dialyzed in tap water for one day, then placed in new dialysis tubing (3500 MWCO) and dialyzed for three days in deionized water. The DI water was changed every day. When the conductivity of the sol dropped to about 300 mHo, the sol was filtered using a 150 micron sieve. In some cases, additional filtration was performed after the tap water dialysis, depending on the quality of the sol resulting from the source material.

Gel formation. The dialyzed sol from the previous step was stirred at room temperature for one hour. 20.7 mL of 0.5 N HCl was added, and the sol was cast into a plastic container. The container was kept at room temperature overnight until a white gel formed. The gel was annealed by placement in water or EtOH in an oven at 55° C. for 24 hours. In some experiments, the recovered gel was transferred to a sealed container with a solvent for storage. Alternatively, the recovered gel was dried for 48 hours in a hood at room temperature to form a resin. The resin was then used as is. It is important to note that the resin could have been ground to form a powder at this step for use in accordance with the present invention.

Grinding, washing and drying. For a dried gel (resin) to be used in powdered form, the resin was ground in a coffee grinder to 355 μm, using a standard test sieve to verify the particle size. The ground resin was washed with tap water (e.g., 25 mL of water/1 g of resin). The resin in tap water was stirred at room temperature until there was no change in conductivity (about one hour). The water was changed and further washing was performed with deionized water after the conductivity came down to about 600 mHo (i.e., the conductivity of tap water). Two washes were performed in DI water until the conductivity was about 25 mHo to 50 mHo (i.e., the conductivity of DI water). The washed solution was filtered each time the water was changed. A final wash was performed using 2-propanol. The resin was filtered, placed into reusable dishes, dried in a hood at room temperature overnight, and then dried under vacuum for one hour.

### Example 4

### Method of Coupling Protein and Polysaccharide Separating Agents

The powdered form of chiral materials prepared in the aforementioned Examples 1-3 may be used. Unsupported chiral polysaccharide materials available from Chiral Technologies, Regis Technologies, Inc. or Eka Chemicals, by way of example, may also be used.

Dry protein-based chiral material, chiral polysaccharide materials, NaCl, and a bifunctional spacer such as poly(propylene glycol) diglycidyl ether (PGDE), or citric acid, were combined in water (or ethanol), and at elevated temperatures and stirred to initiate the reaction of the ether with the reactive groups of the protein and polysaccharide. The spacer was at, for example, 5% load of chemical linker by weight. The material was filtered, dried, and then cooled down to room temperature in a dessicator. The dried powder was sieved to obtain particle size fractions.

### Example 5

### Methods of Packing Chiral Powder to Form a Separations Column

Packing procedure: Material such as the material prepared in Example 4 was slurried using isopropanol, or hexane and pumped into a pre-column reservoir at 1000-8000 psi. The reservoir was connected to an empty column casing 1-10 cm long and 0.3-2 cm in inner diameter. When the column was full, the sealed column was used for normal phase HPLC. The columns may also be packed with particles having different particle sizes, for example, particles in the 5-25 micron range, particles 25 microns and smaller (no fine particle cut-off), and particles 25-100 microns. The largest particle columns can generally tolerate higher proportions of water in the mobile phase.

As will be apparent to one of ordinary skill in the art from a reading of this disclosure, the present invention can be embodied in forms other than those specifically disclosed above. The particular embodiments described above are, therefore, to be considered as illustrative and not restrictive. In addition, the invention includes each individual feature, material and method described herein, and any combination of two or more such features, materials or methods that are not mutually inconsistent.

### Additional Example and Constructions

### Example 6

### Crosslinking Using Epoxy Terminated Ligands and Alcohol as a Solvent

In accordance with the present invention, the following example illustrates crosslinking with epoxy terminated ligands using alcohol as a solvent using 5 g of biopolymeric material particles, 300 mL of ethanol, 10 mL of epoxy crosslinker (i.e., poly(propylene glycol) diglycidyl ether) and 1 N HCl for titration (approximately 1-2 mL).

First, the particles were suspended in the ethanol and stirring was started at room temperature.

Next, the epoxy crosslinker (i.e., poly(propylene glycol) diglycidyl ether) was added and the suspension was stirred for one hour to allow the epoxy crosslinker to diffuse through the particles. While the particles and epoxy mixture in ethanol was continually stirred, the temperature of the mixture was raised to 60-70° C.

When the mixture reached 60° C., the solution was acidified to start the crosslinking reaction. 1 N HCl was carefully added, drop by drop, until the solution reached a pH of 4. With the temperature maintained between 60-70° C., the reaction was allowed to run for one hour.

The reacted material was then transferred to a buchner funnel with 2 sheets of filter paper (coarse/Qualitative on top of fine/quantitative). Using a vacuum, the liquid was pulled off of the reaction mixture in the buchner funnel. Ethanol was then rinsed through the material, and a filtering funnel was used to remove any leftover epoxy. Using about 500 mL of alcohol, the material was rinsed five times. Water was then rinsed through the material to remove any leftover acid.

A final rinse with ethanol put the material into a solvent system compatible with packing.

### Example 7

### Surface Modification with Common Ligands

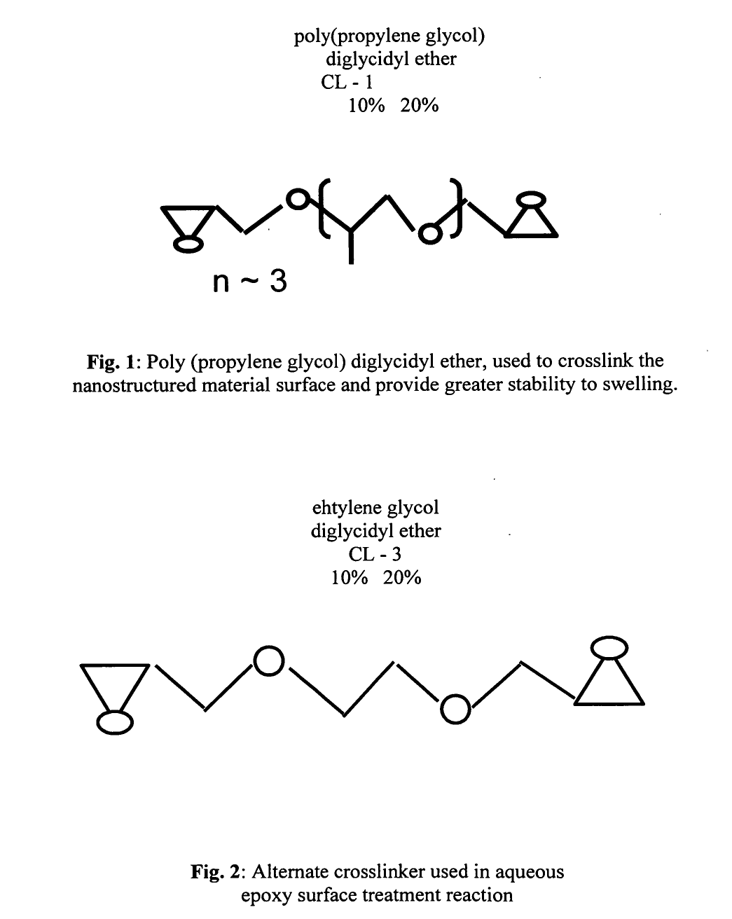

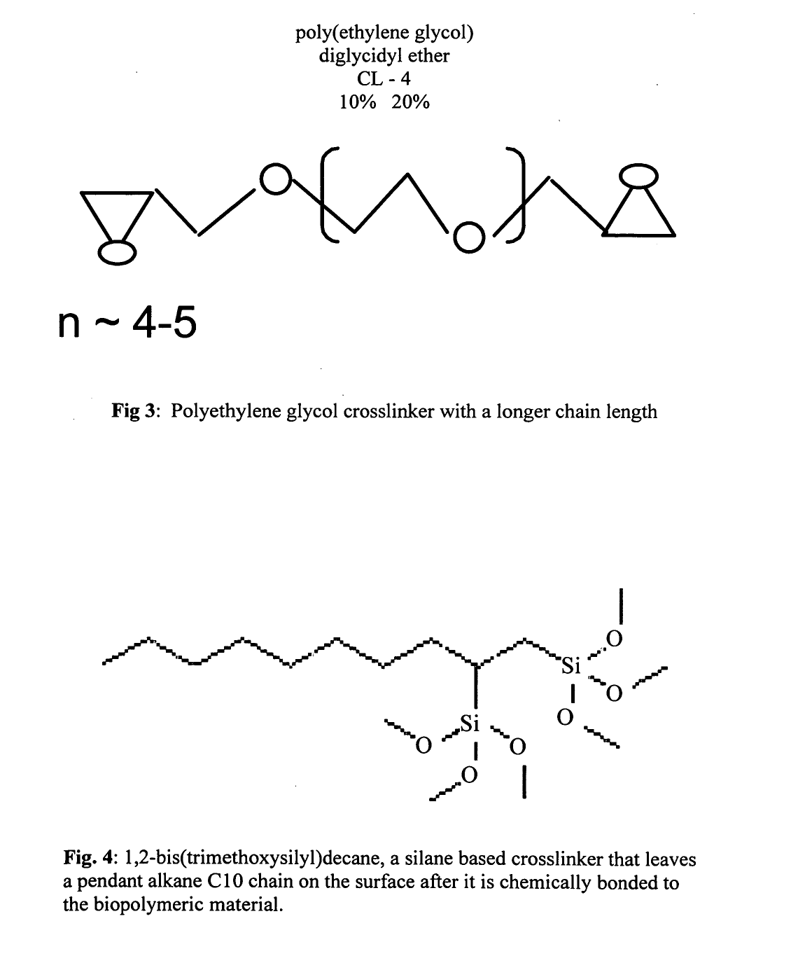

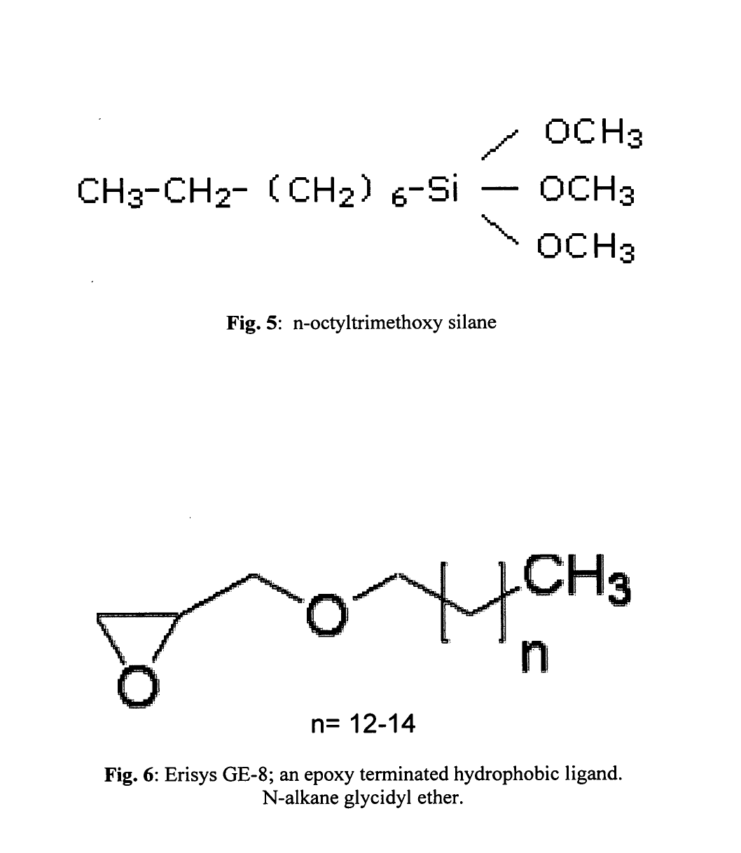

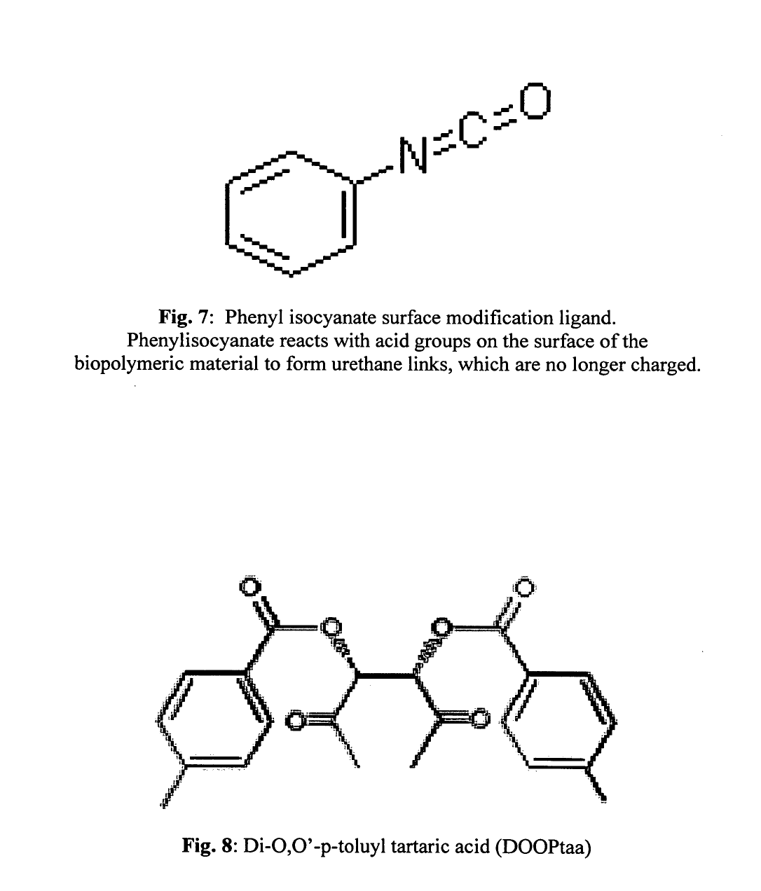

Using the method of the present invention, surface modification was accomplished using a number of common ligands, including diglycidyl ethers, citric acid, ethoxy silanes, methoxy silanes and phenyl isocyanate (examples of such ligand molecules are shown in FIGS. 1-7). Other reactions addressing chemical groups typical of proteins may also be possible.

In the following example, surface modification with a silane crosslinker and a ligand was accomplished using: 900 mL of alcohol for reaction (anhydrous reagent alcohol, CAS# 9229-03); 150 additional mL of alcohol for rinsing; 600 microliters of 1,2-bis(trimethoxysilyl)decane crosslinker; 6 mL of octyltrimethoxysilane; 15 g of biopolymeric particulate material; 30 mL of 1N aqueous HCl; 5 mL of glacial HCl; and DI water and isopropyl alcohol (IPA) for rinsing.

900 mL of alcohol was added to a 2 L beaker to which 15 g of particulate material was then added. This mixture was homogenized at 4,000 rpm for 1 minute.

Next, 600 microliters of 1,2-bis(trimethoxysilane) crosslinker was added and the mixture was stirred for 1 hour with no heat to allow the reagents to diffuse into the material. This also allowed the silane to find the acid on the surface of the solid particulate. Then, 30 mL of 1N HCl was added to hydrolyze the silane until a pH of 4 was reached. This mixture was reacted for half an hour at ambient temperature to crosslink the particulate. Then, 6 mL of octyltrimethoxysilane ligand was added. Because this ligand requires more acid for hydrolysis, 100 mL of water was added next to ensure hydrolysis and to allow better pH monitoring. This was followed by the addition of glacial acetic acid until a pH of approximately 3-4 was obtained (tested using pH paper). As the ligand hydrolyzed, the acetic acid smell faded significantly. This mixture was reacted for one hour, after which the solvent was removed by filtration. The particles were then rinsed with IPA to remove excess silanes, then rinsed with water to remove acid, then rinsed with IPA and then rinsed with hexane to promote faster drying. The particulates were then vacuum dried and sized.

In the following example, surface modification was accomplished with a silane crosslinker followed by Epoxy C12-14 ligand using 5 g of biopolymeric material particles; 300 mL of reagent alcohol, anhydrous; 1,2-bis(trimethoxysilyl)decane (FIG. 4); 2 mL of n-dodecyl glycidyl ether, Erisys GE-8; and 100 microliters of glacial acetic acid.

5 g of biopolymeric material particles were added to 300 mL of reagent alcohol in a 100 mL flask. While this mixture was stirring, 100 uL of 1,2 bis(trimethoxysilyl)decane (silane crosslinker) was added and the pH was checked and found to be approximately 4. This mixture was stirred for 10 minutes and then 100 mL of glacial acetic acid was added and the mixture was stirred for 20 more minutes. The flask was then set up on a heating bath, but the heat was not yet turned on. Next, 2 mL of Erisys GE-8 was added (epoxy ligand) followed by 30 more minutes of stirring with no heat. The heat was then turned on and brought to 60° C., while stirring was maintained. The mixture was allowed to react for 2 hours at 60° C. After the reaction, the particles were decanted into a filtering funnel and rinsed with alcohol, then left to air dry. Particles were vacuum dried prior to HPLC column packing.

Similar reaction conditions can be configured for epoxy crosslinkers and ligands (in alcohol), silane ligands and crosslinkers, isocyanates, acid chlorides, anhydrides and other types of simple well-known chemical reactions in varying combinations and orders to obtain a desired surface chemistry (see also Example 6). As stated above, additional examples of ligands are shown in FIGS. 1-7.

### Example 8

### Artifacts Decrease and Chiral Performance in HPLC Improves with Increased Coverage of the Chiral Biopolymer Chemistries on the Materials Surface

The traditional method of using different solvents to bind and elute compounds is not compatible with the way chiral HPLC is performed and scaled for preparative separations. Chiral HPLC separations are generally performed under isocratic conditions, i.e., conditions where the solvent does not change. The surface chemistry of a material used in a chiral HPLC column must thus be fairly “slippery”, but still be wettable by the solvent. This provides a selective slowing of one of the enantiomers relative to the other, resulting in a distinct separation given a sufficiently long HPLC column.

Because the biopolymeric material used in the HPLC column is fabricated from a biopolymer with charged, polar groups, the unmodified surface of the biopolymer material particles is not traditionally slippery. Instead, the unmodified surface is fairly “sticky” and adsorbs analytes strongly. Analytes with a high polarity or charge stick to the surface of the material in the HPLC column, requiring one of the more aggressive solvents to remove them. In order to avoid this complication, the surface chemistry of the material is modified.

Other typical materials used for chiral HPLC columns feature chemistry-based selection, or a molecule-to-molecule matching effect which requires that the molecular features used in, and important for, chiral selection remain intact. If the wrong portion of the chiral selector molecule is modified to improve surface chemistry, chiral selectivity can be lost. The need to retain the molecular structure of a chiral selector molecule indicates that modifications made to the surface of the material must be done carefully in order to preserve chirally important aspects of the surfaces picostructure. This is important since this is the scale at which molecular subunits interact for chiral selectivity.

In the case of the novel biopolymeric materials of the present invention, chiral selectivity occurs due to nanoscale features of the structure of the material. Chemical modifications that alter or even obliterate picoscale features should not and do not affect the chiral selectivity. Far more aggressive surface modification can be used to address the non-chiral properties of the material, removing performance limitations inherent in chiral molecule-based, conventional picoscale selection.

A test compound, Di-O,O′-p-toluoyl tartaric acid (DOOPtaa, FIG. 8) is strongly retained on HPLC columns packed with very lightly surface-modified novel chiral biopolymeric material particles. In these particles a small proportion (e.g., less than 10%) of the particulate material was modified with a crosslinker to stabilize the particles against swelling. Emulsion chemistry was used with an epoxy crosslinker, resulting in a chemical modification predominantly on the outer surface of the particles, leaving pore and channel walls with essentially unmodified chemistry. Much of the surface chemistry from the chiral biopolymer used to form the particulates was thus still accessible to analytes. This is slightly more aggressive, but similar to the approach one would take using the novel molecular chiral selector disclosed above, where much of the chiral picoscale structure is both preserved and accessible after surface modification. DOOPtaa simply stuck to this HPLC column, and no isocratic HPLC separation results could be obtained. The diglycidyl ether in FIG. 1 was used alone and in conjunction with the n-octyl glycidyl ether ligand in FIG. 6.

More complete surface coverage was obtained by extending the reaction time from 1 hour to 24 hours. This long reaction time provides the poorly soluble epoxide ligands time to diffuse into the pores and channels of the biopolymeric material as continued surface modification makes more of the surface hydrophobic and wettable by the ligand in emulsified droplets.

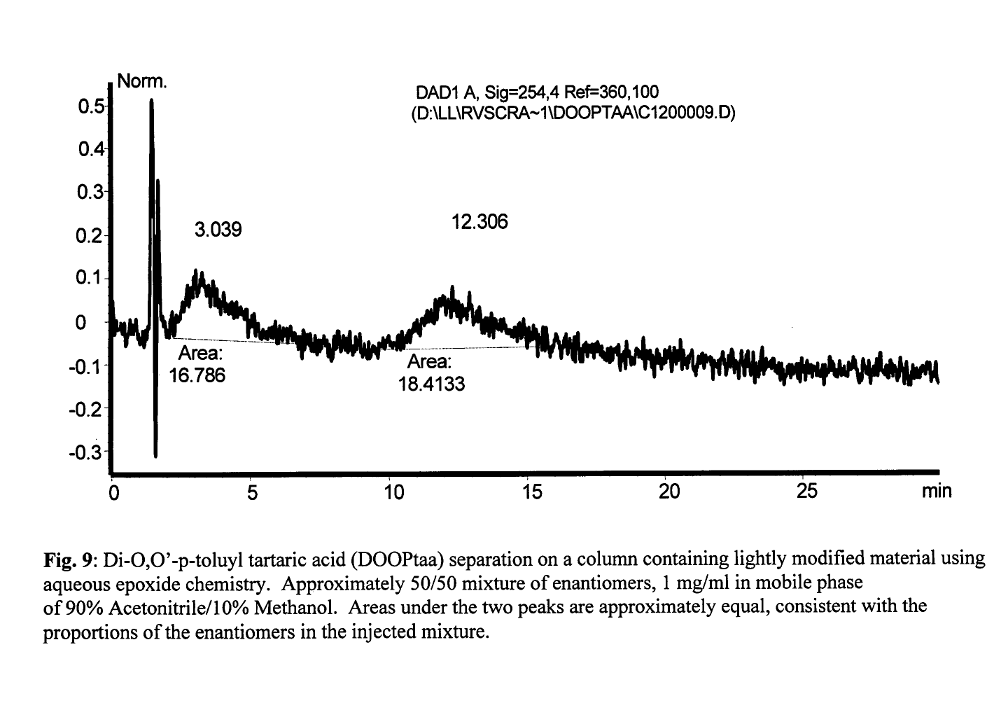

The increased surface coverage is reflected in the HPLC data. A HPLC column packed with this “long reaction time” material no longer completely retains the analyte. As can be seen in FIG. 9, some of the DOOPtaa elutes, and a chiral separation is observed for the eluted DOOPtaa. Much of the analyte remained stuck to the HPLC column, and was only removed in subsequent aggressive washing gradients. Of note is that the chiral chemistry on the surface of the material has been partially covered by achiral C10-12 “fuzz” to obtain this separation. The chiral molecular structures at the surface of the material are less accessible due to these fuzzy alkanes attached to the surface during modification. This is a far more comprehensive surface modification than would be possible using a conventional molecular structure-based chiral selectivity mechanism, where only subtle derivatization reactions are typical. Yet, chiral selectivity and separation are observed in HPLC columns packed with the coated material. The separation was verified using the individual DOOPtaa enantiomers.

Still further surface coverage was obtained by reacting the epoxy ligands with the surface of the chiral biopolymeric material in alcohol. Alcohol is a good solvent for the epoxy ligands, and provides a homogeneous liquid phase that can penetrate into the pores and channels of the particles readily. In addition to ensuring good homogeneous coverage of the chiral picoscale features of the material, the more thorough modification allows more highly ionizable surface chemistry from the chiral biopolymer. This biopolymer is used to make the material to be covered up and reacted with achiral non-ionizing alkane chains and stable ester and ether linkages.

The result of functionalization is twofold. First, chemical sites from the biopolymeric material which could provide non-novel chiral recognition and selectivity are covered up and inaccessible. This is significant as only the novel nanoscale structure and associated novel mechanism remain. Secondly, the surface was chromatographically passivated. Ionizable groups at the surface were converted to neutral chemical links, which are stable under most chromatographic conditions. This eliminated many of the artifacts that can overwhelm the chromatographic separation.

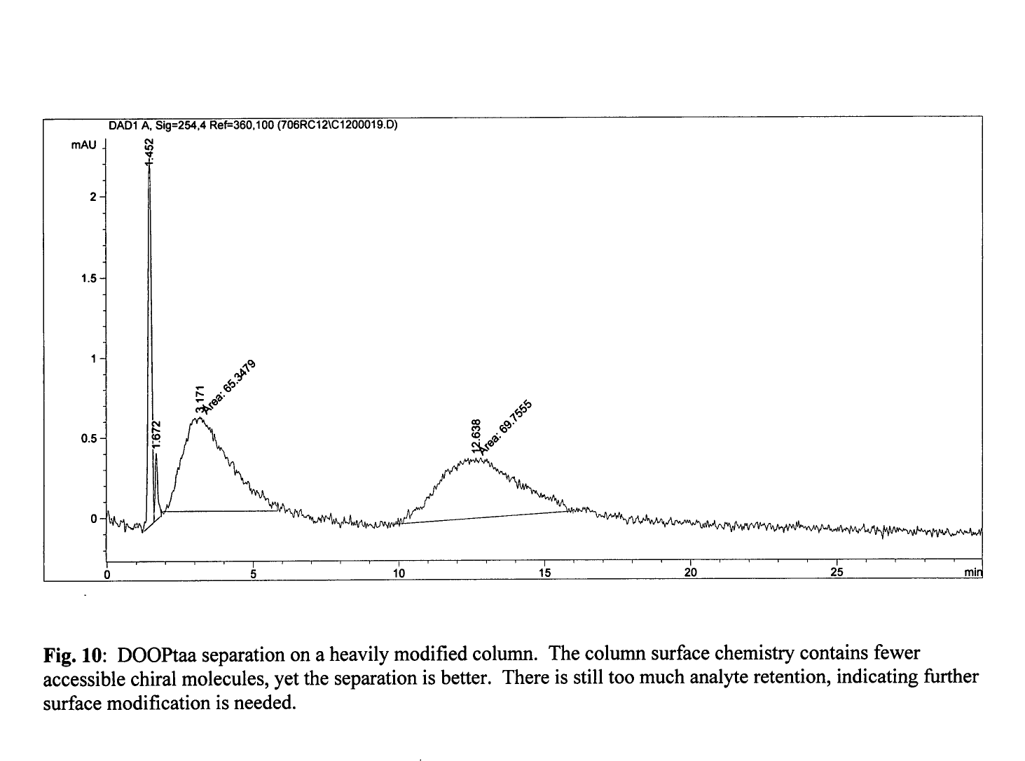

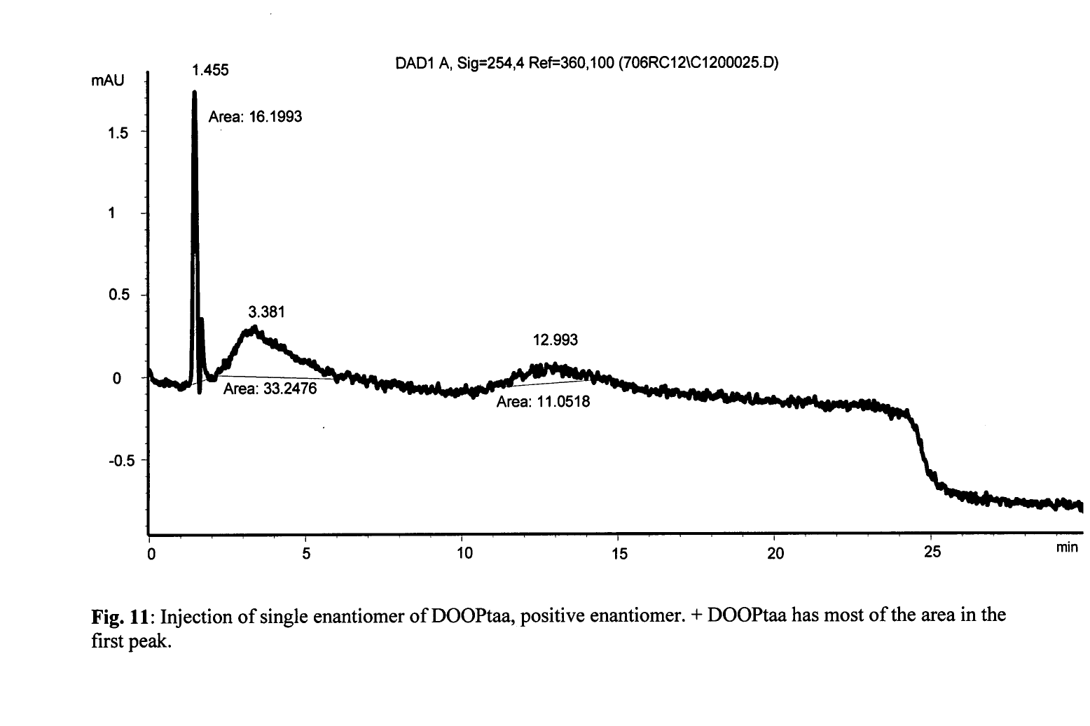

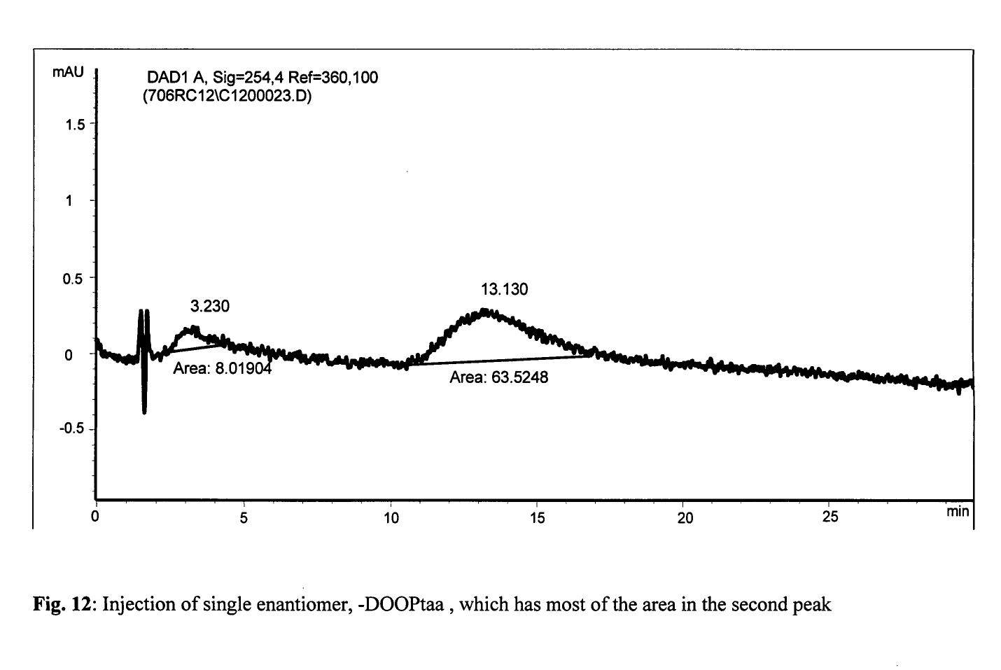

Several samples were injected on a thoroughly reconditioned HPLC column with C8-C10 chemistry on the surface, and the resulting chromatogram is shown in FIG. 10. Isocratic HPLC on DOOPtaa indicated selectivity, a chiral separation was observed and confirmed with individual enantiomers as can be seen in FIGS. 11 and 12. While there is still a problem with the analyte sticking to the HPLC column, this is greatly reduced in the very heavily coated HPLC column, and peak shape is also improved. Again, there is far less (or possibly none) of the biopolymer's chiral surface chemistry accessible, yet the chiral separation behavior of the HPLC column is far better than when the material had many more exposed molecular structure scale chiral selection sites. This is the exact opposite of what a conventional molecule-based mechanism would predict.

The results observed from DOOPtaa indicate that chiral selectivity in these novel biopolymeric materials does not depend on particular chiral molecules, groups, or picoscale sites on the materials surface. Furthermore, the novelty of the mechanism allows for far more aggressive and comprehensive approaches to surface modification. The chemical approaches used in the aforementioned examples are bonded coatings rather than delicate site-specific derivatizations. The ability to completely modify the surface chemistry without the loss of chiral selectivity allows for more economical engineering approaches and allows systematic elimination of the chromatography artifacts that have plagued chiral separation.

### Example 9

### Evidence of Surface Changes After Modification

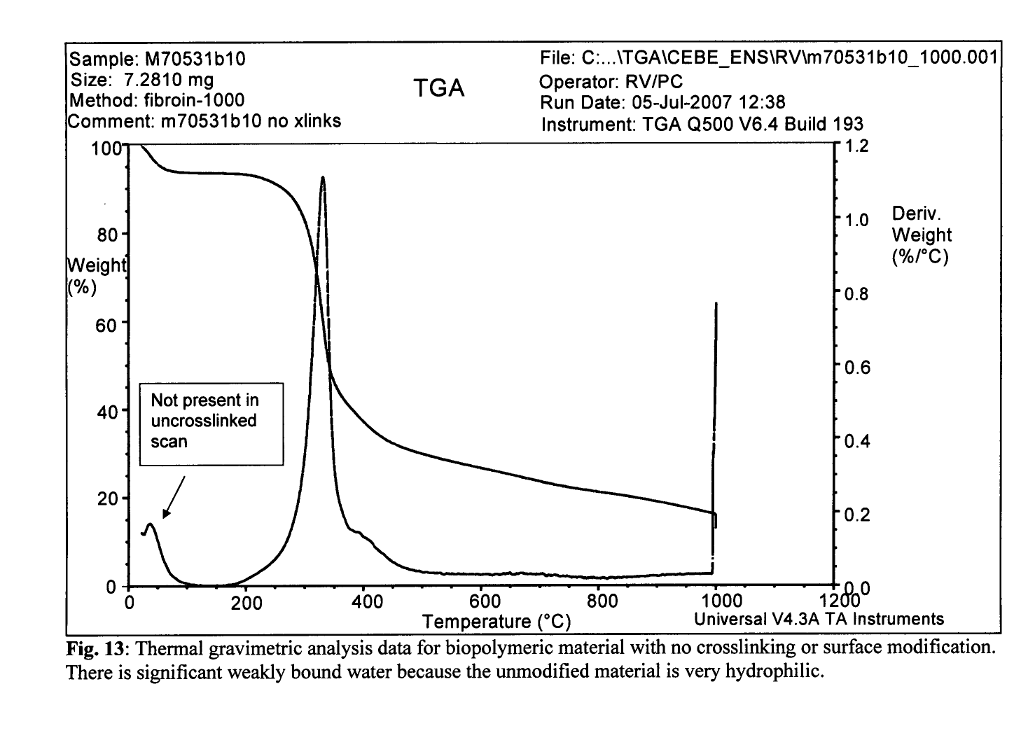

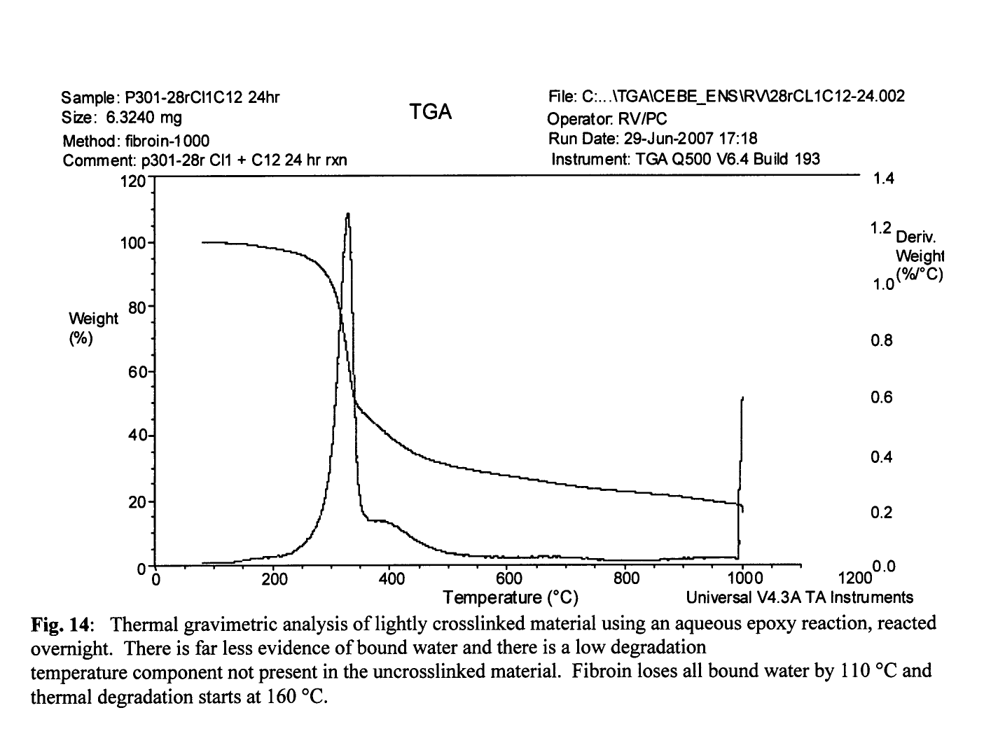

Uncrosslinked materials were observed to swell 20-50% when soaked in water for one hour, using a simple volumetric measurement in a test tube. Crosslinked materials had no observable swelling. Similarly, when uncrosslinked materials were wet by water, they were made sticky and clogged filtration apparatuses when small particulates of the material were being handled. After crosslinking, wetting and clumping behavior in water were markedly different, and there was no tendency to form dense wet clogs upon filtration of small particulates. Thermal gravimetric analysis (TGA) measurements on particles stored in the open (i.e., exposed to atmospheric moisture) made from uncrosslinked materials and materials crosslinked in an aqueous reaction indicated significant mass loss due to bound water in thermal gravimetric analysis, as shown, for example, in FIG. 13. No detectable mass loss due to bound water was observed for alcohol-crosslinked particles, as seen in FIG. 14. In addition, infrared (IR) measurements on alcohol crosslinked and heavily-modified materials using epoxide chemistry indicated a loss of acid functionality in the crosslinked and modified materials. This was observed as the disappearance of a broad band at around 3300 cm⁻¹. HPLC columns containing material which was not crosslinked exhibited unstable variations and irrecoverable severe increases in backpressure when exposed to solvents containing as little as 10% ethanol, and were unstable in methanol and water. When the materials were heavily crosslinked and modified using epoxy chemistry, e.g., glycidyl ether and diglycidyl ether ligands, (see FIGS. 1-3 and 6) where the reaction was aqueous, the columns were still unstable in ethanol and methanol, but backpressure rose more slowly over the course of 10-50 injections. After crosslinking the material using the same epoxy ligand, dissolved and reacted in alcohol (as described in Example 6), the material was stable in HPLC columns in alcohol solvents and in up to 20% water. Similar results were observed when silane chemistry was added, where HPLC columns packed with the modified materials exhibited negligible backpressure due to swelling in a wide range of solvents, including water and solvents not typically used for chiral chromatography such as ethyl acetate and methylene chloride. These solvents are known to dissolve and swell the coatings used in other HPLC column materials made using conventional approaches.

### Example 10

### Coating the Surface with Thick Achiral N-Alkane “Fuzz” Improves Chiral Separation Performance

As described above in Example 9, the novel chiral selectivity mechanism in the biopolymeric materials is derived from the nanostructure or morphology of the material, rather than from specific chiral molecular species which may be accessible at the surface of the material. The chiral molecular species that may or may not be present at the surface of the novel biopolymeric material can be modified, reacted, and covered over without losing the chiral selectivity mechanism of the biopolymeric material. In accordance with the present invention, it has been shown that removing accessible chiral molecules and groups on the surface of the biopolymeric material, or rendering them inaccessible with a thick coating, actually improves the chiral separation performance of the material in an HPLC column. In all of the examples, the ligands and chemistries used placed alkane C8-12 on the surface of the biopolymeric material. Light coverage thus leaves more chiral chemistry from the biopolymer exposed, whereas heavier coverage results in a less chiral surface chemistry.

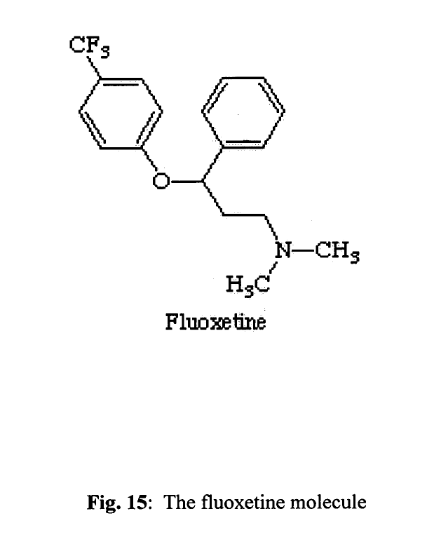

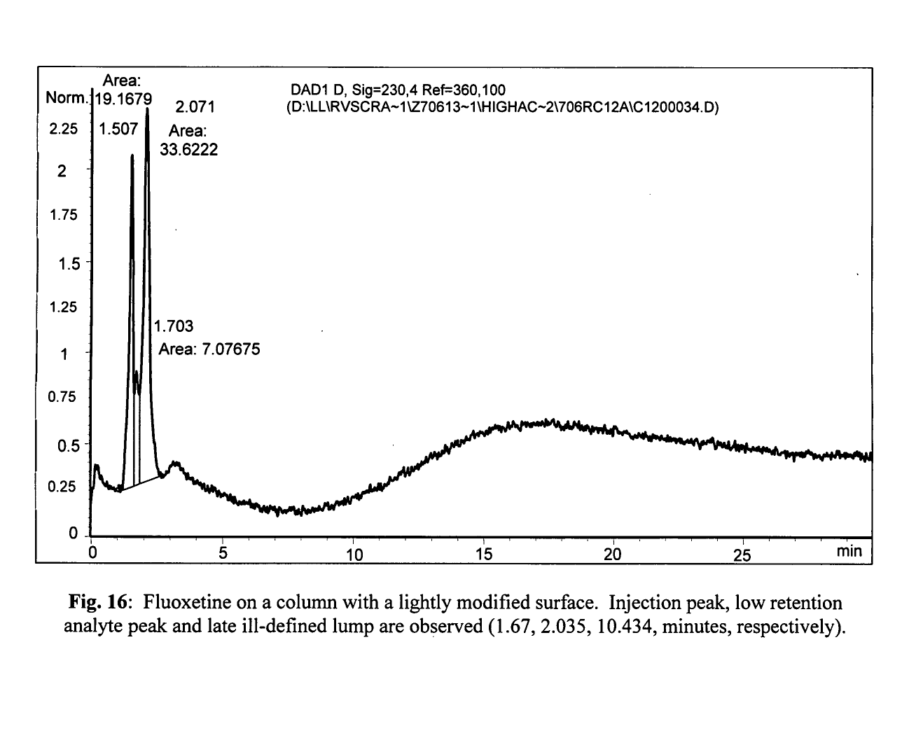

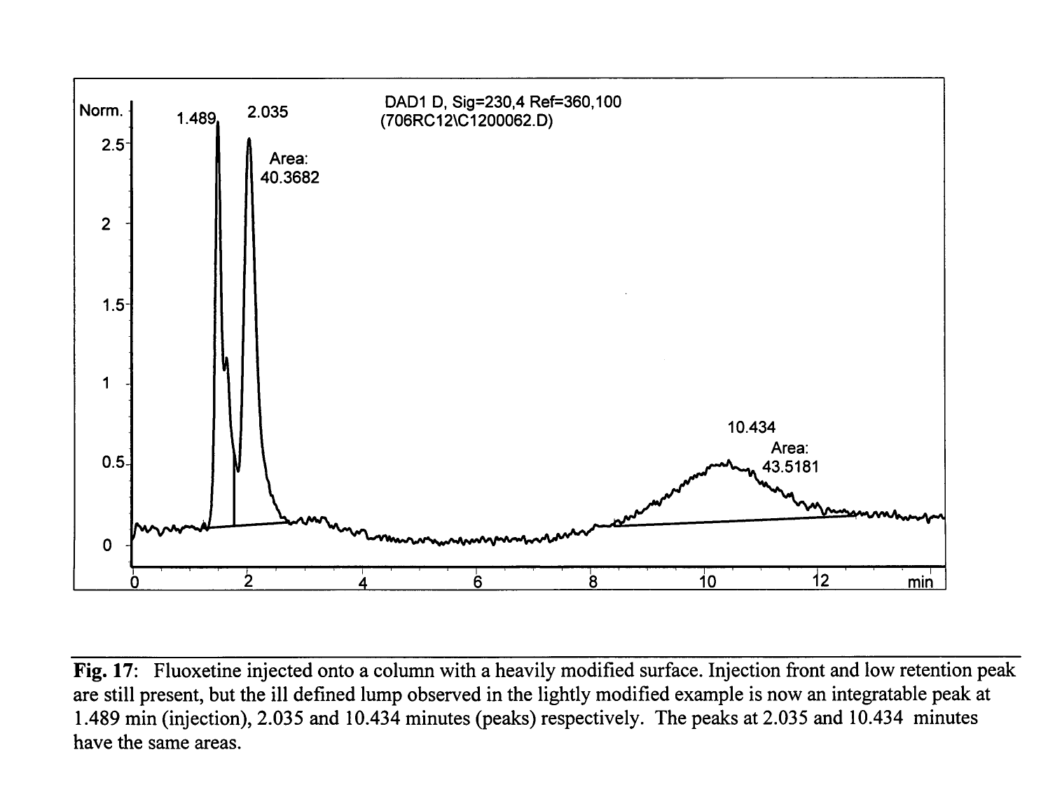

In one embodiment, fluoxetine (see FIG. 15) was injected using 90/10 ACN/MeOH. Fluoxetine was heavily retained on the lightly surface treated HPLC column and only one analyte peak was clearly observed, eluting close to the void volume peak, as seen in FIG. 16. Analytes were overly retained on the more heavily modified HPLC column, but heavier surface modification improved elution of both analytes and prevented smearing of the retained enantiomer peak into the background noise, as seen in FIG. 17.

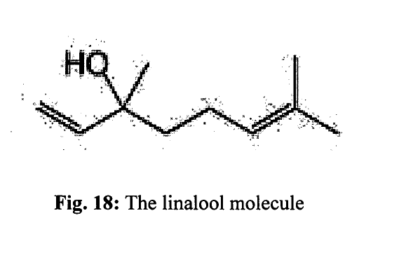

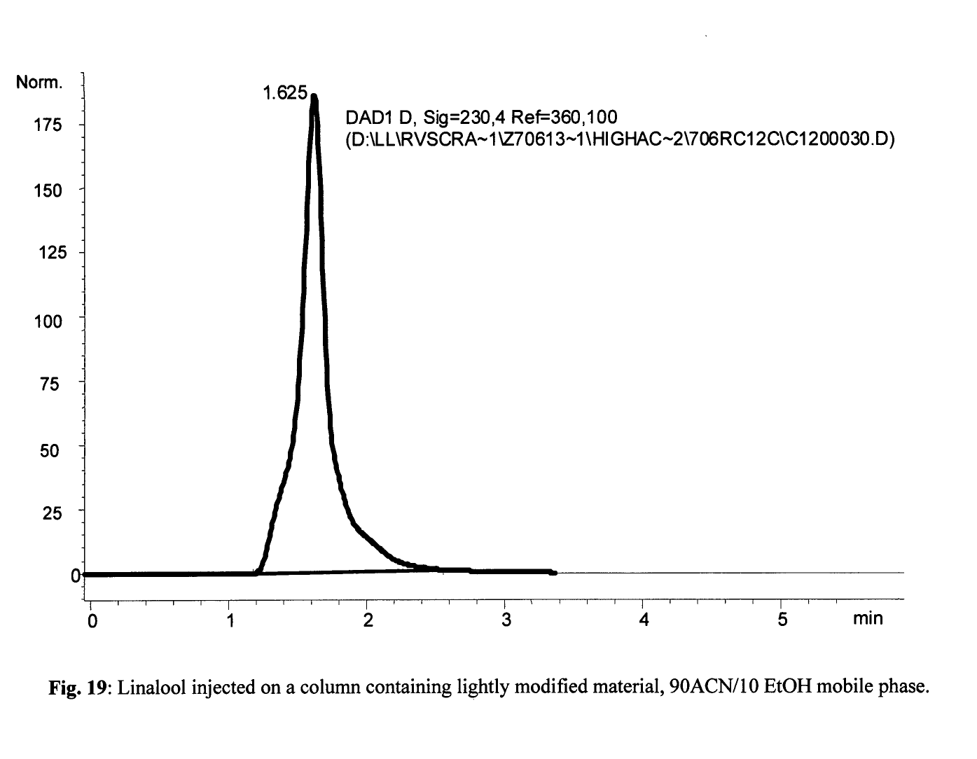

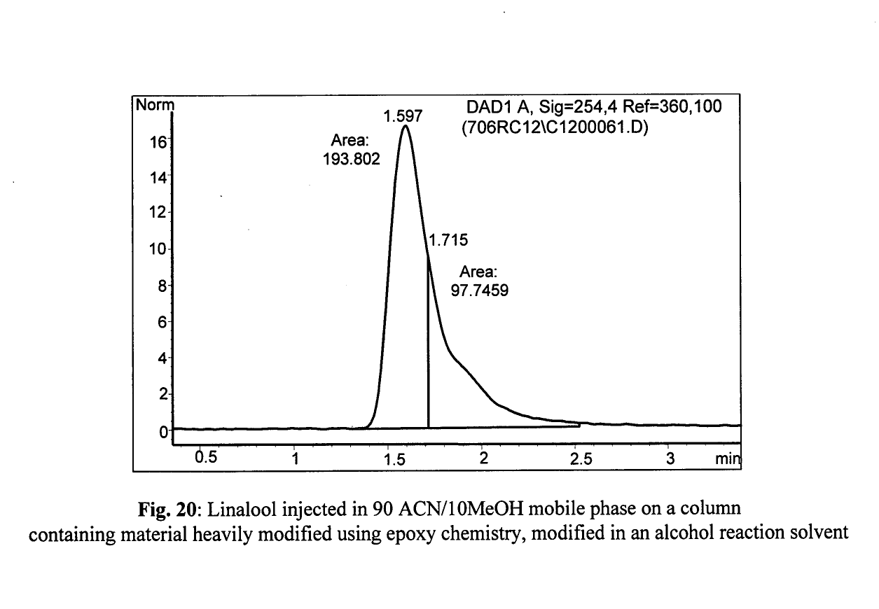

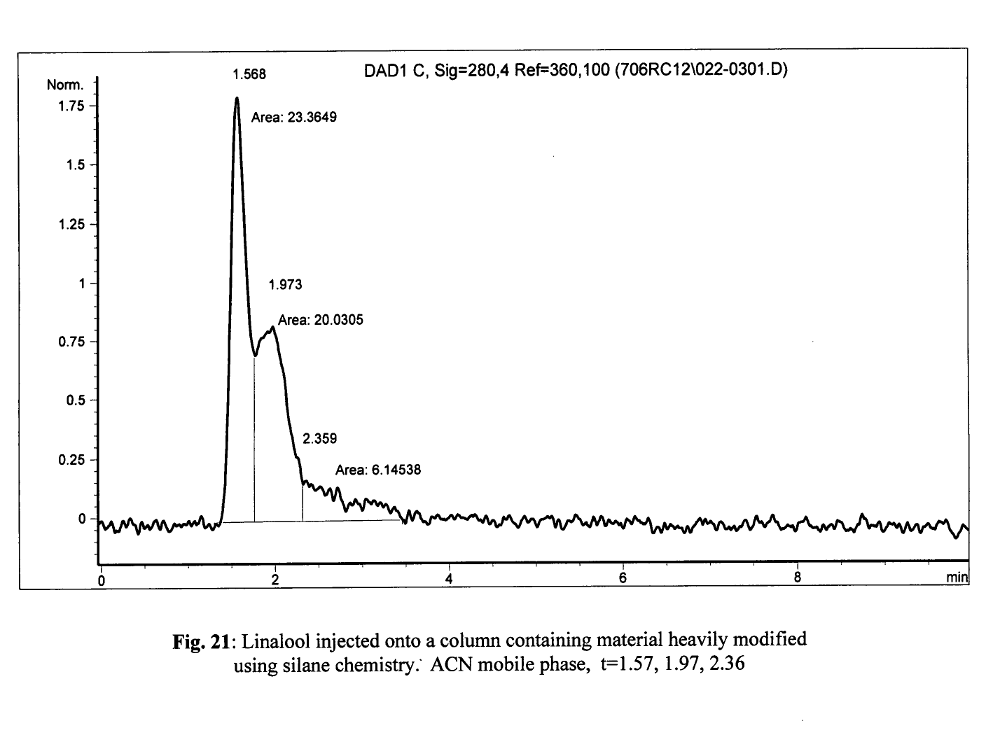

In another embodiment, linalool (see FIG. 18) was injected into a HPLC column comprising a lightly modified material. Linalool produced a single “lumpy” peak (see FIG. 19). In contrast, when Linalool was injected into a column with a more heavily modified material, a clear shoulder (a sign of chiral selectivity) was observed (see FIG. 20). With HPLC column material heavily modified using silane chemistry, which is a more efficient coating reaction, linalool displays two peaks, as seen in FIG. 21. Chiral selectivity on the silane chemistry-modified HPLC column was confirmed using an in-line chiral detector and comparisons with single enantiomer runs.

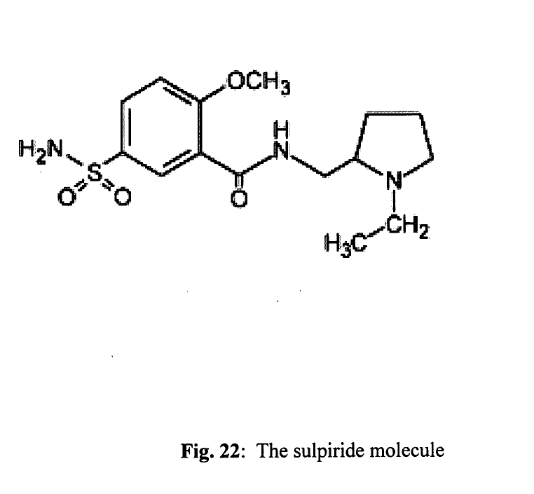

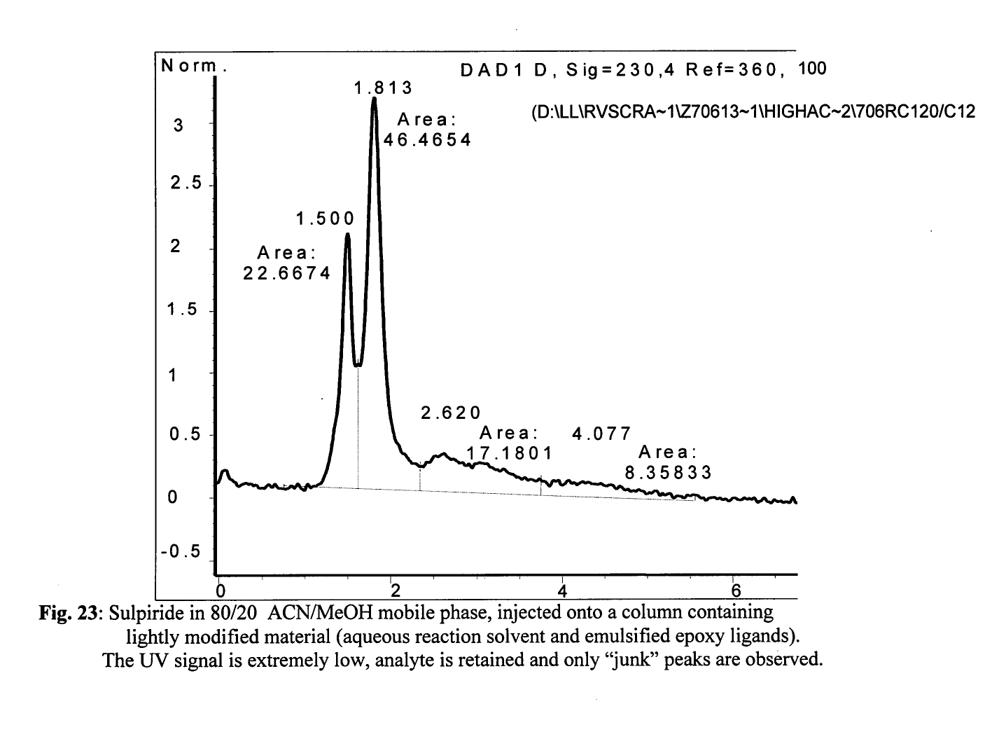

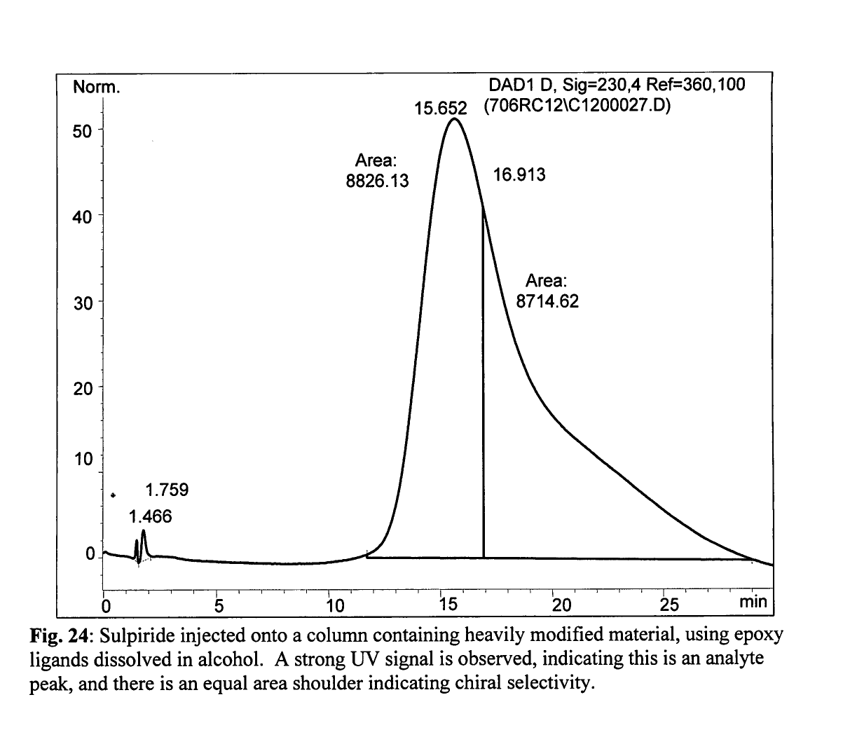

In another embodiment, sulpiride (see FIG. 22) was injected in 80 ACN/20 MeOH and retained on a HPLC column containing lightly modified material and only “junk” peaks with low UV signatures were observed (see FIG. 23). In contrast, a heavily modified material on the HPLC column resulted in some selectivity for sulpiride, as evidenced by the shouldered peak and much higher UV signal (see FIG. 24).

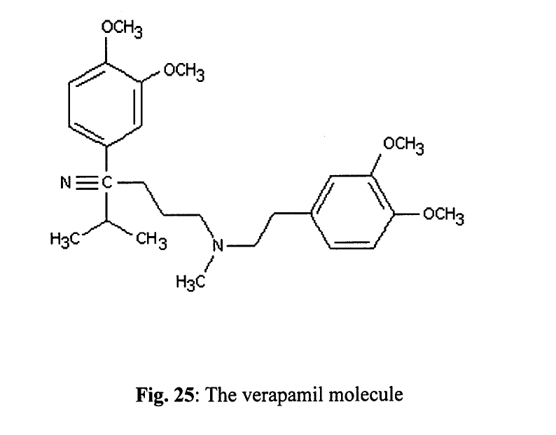

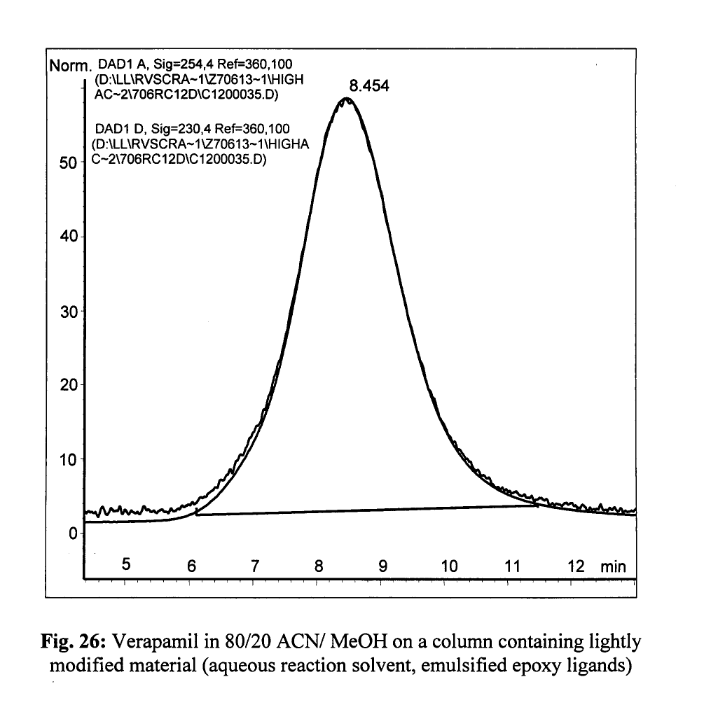

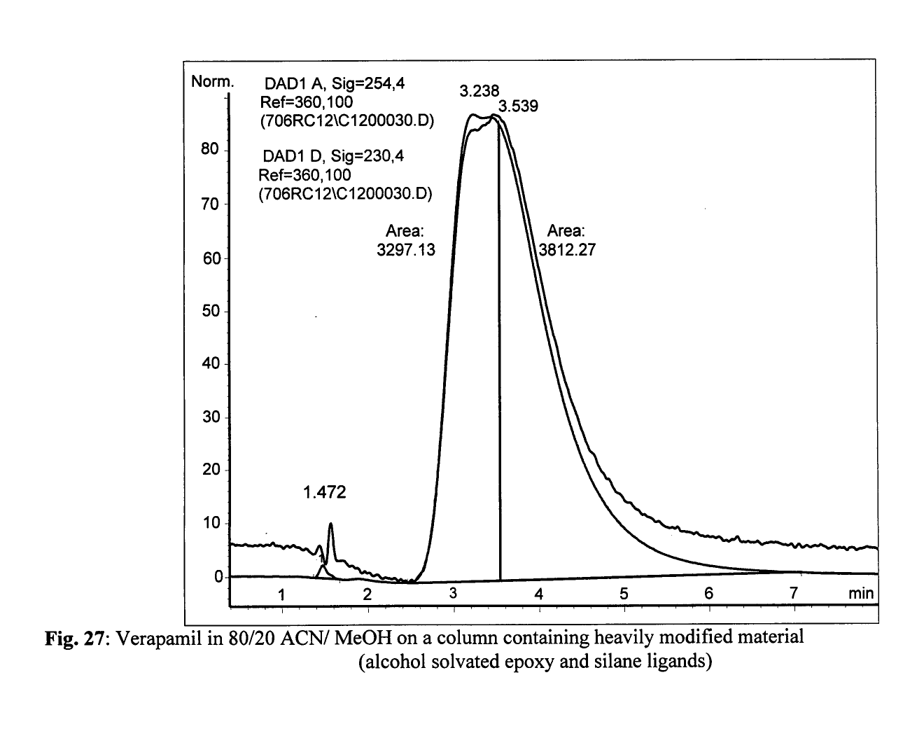

In another embodiment, verapamil (see FIG. 25) was injected in 80% acetonitrile, 20% methanol on a HPLC column containing slightly modified material. There was no evidence of chiral selectivity for verapamil, however, with a heavily modified material, a peak with two crests (i.e., two “overlapper” peaks) was observed.

### Example 11

### HPLC Data from Lightly Modified Chiral Polymer Surfaces

A chirally-active support coated with an epoxy crosslinker, polypropylene (n=4-5) diglycidyl ether, reacted with the chiral material (at 10% by weight crosslinker to chiral polymeric material) overnight in acidified water at 30° C. The reaction efficiency for this method of crosslinking is typically low, thus a 10% by weight loading of crosslinker ligand in the reaction vessel resulted in a crosslinker proportion of considerably less than 10% of the chiral particle mass. These particles exhibited increased swelling resistance in water after crosslinking, but the amount of crosslinking ligand present was below the detection limit for TGA. This is thus a moderately modified surface chemistry, with some of the chiral and chemical functionality of the original biopolymer still intact and accessible. Because the particles were coated by impacting reactive emulsion droplets in a multiphase reaction mixture, the outer surface of each biopolymeric material particle was more heavily coated than the walls of the pores and channels within each particle.

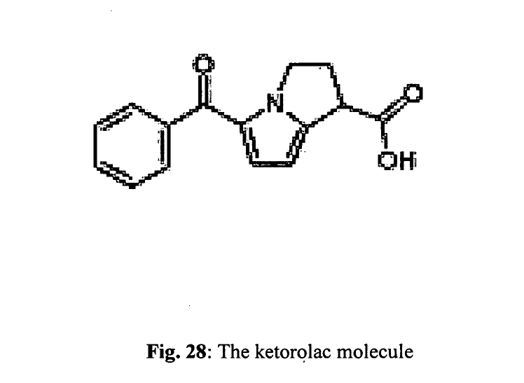

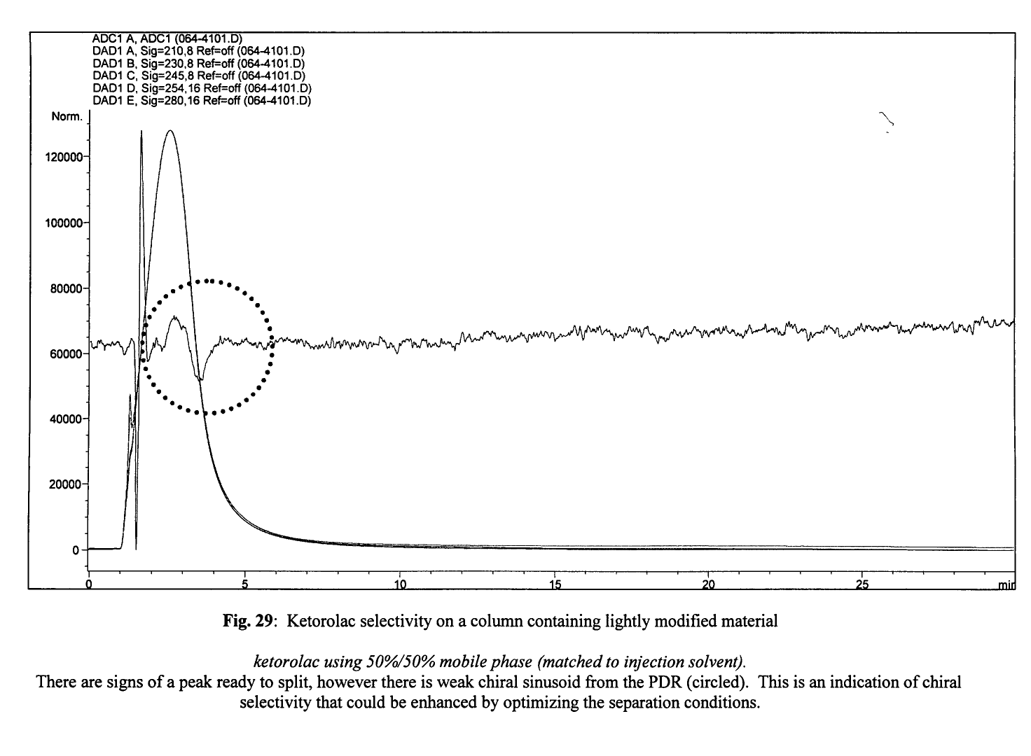

Ketorolac (see FIG. 28) was injected into a 5 cm long, approximately 0.5 cm inner diameter HPLC column containing 10 micron particles of chiral biopolymer (unsupported). The biopolymer formed a chirally-active polymeric support, which was then coated with epoxy crosslinker, polypropylene (n=4-5) diglycidyl ether reacted with the chiral material. The reaction was run in an aqueous solvent (water titrated to a pH of 4-5 with acetic acid). Crosslinking ligand (diglycidyl ether) was added (at 20% by weight crosslinker to chiral polymeric material) and reacted overnight in acidified water at 30° C. The reaction efficiency for this method of crosslinking was typically low, thus 20% added crosslinker resulted in a surface chemistry that significantly modified at the parts of the surface accessible to the crosslinker in an aqueous reaction system. The particles crosslinked under these conditions exhibited different wetting behavior, indicating a significant hydrophobic alteration to the surface of the particles. In this case, the crosslinking ligand formed an emulsion and only addressed the outer surface of the particle. These particles exhibit increased swelling resistance in water after crosslinking, but the amount of crosslinking ligand present was still below the detection limit for TGA. This thus remains a lightly modified surface chemistry, with most of the chiral and chemical functionality of the original biopolymer still available and intact.

The signal obtained from a UV detector indicated when the analyte was coming off of the HPLC column, and was used to distinguish chemically unrelated contaminants. The chiral detector signal occurred after a short delay, because the solution coming off of the HPLC column needed time to exit the UV detector cell and enter the chiral detector cell. The chiral detector measured only optical rotation. If the solution entering the detector cell was enriched in a “(−)” rotating enantiomer, a negative signal (below baseline) was observed. If the solution was enriched in a “(+)” rotating enantiomer, a positive signal is observed. Because of the resolution of the UV detector and the shape of the time dependent concentration gradient (e.g., the natural chromatographic peak shape) exiting the column, two peaks, or fractions that are heavily overlapped, appeared as a single peak with a single crest in a UV detector, yet were still enriched chirally at the leading and trailing edge. Any enrichment to the leading or trailing edge is a sign of chiral selectivity.

A solution of ketorolac, approximately 10 mg/mL, which was prepared in a solvent consisting of 50% ethanol and 50% methanol was injected onto an HPLC column containing approximately 2 g of 10 micron chiral particulate material, surface coated with epoxy crosslinker. The HPLC column was on an Agilent 1100 HPLC with an in-line multiwavelength UV detector and an in-line chiral detector.

In this example, there was leading and trailing edge chiral enrichment of ketorolac, indicating that the HPLC column and the crosslinked material inside the HPLC column are chirally selective for ketorolac. Optimization of the HPLC conditions or the column material can also be used to improve the chiral selectivity.

### Example 12

### Surface Chemistry Treatment Changes Chromatographic Behavior of Material

Linear 8-10 carbon alkane chains were attached to the surface of the material through a methoxysilane reactive site at the end of the ligand. Additional 8-10 carbon alkane chain ligands were attached through diglycidyl ether reactive sites using epoxy ring opening chemistry. The two different types of ligand reactive site chemistries reacted preferentially with different sites on the protein, ensuring maximum coverage by the ligand, and maximum consumption of ionizable groups on the protein surface through functionalization chemistry. Consumption or conversion of ionizable groups passivated the chromatographic material, reducing strong interactions and other slowly equilibrating effects that interfered with peak shapes and chiral separation.

Neutral analytes, unretained on materials with a moderately hydrophobic polypropylene surface treatment, were retained when a more highly hydrophobic C8-C10 surface treatment was applied. Retention on the HPLC column was achieved by making the HPLC mobile phase (i.e., the carrier solvent) less polar. In HPLC chromatography terms, the material was still behaving as if there was some polarity on the surface. The solvents pulled different molecules off an HPLC column packed with the material follow a normal phase order. As the solvent became more polar, it pulled analyte molecules off the surface treated material in the column more strongly.

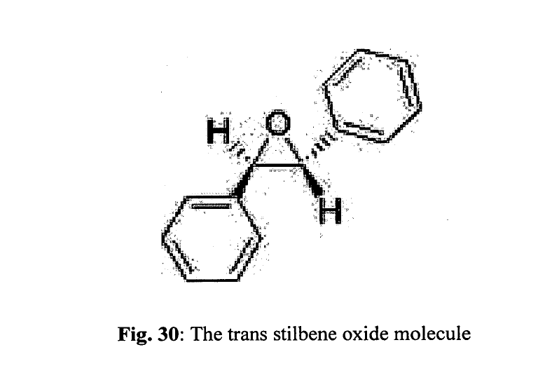

Trans stilbeneoxide (TSO) (see FIG. 30) was unretained (i.e., not delayed at all) in a HPLC column packed with material surface treated with polypropylene diglycidyl ether. In a HPLC column packed with material surface treated with C8-C10, a small amount of retention was noted. Pure solvent took 1.5 minutes to pass through the C8-C10 column. TSO required 1.77 minutes in an aqueous mobile phase consisting of 20% water and 80% methanol, slightly longer if the water content of the mobile phase was decreased to 10%. Methanol is a highly polar alcohol.

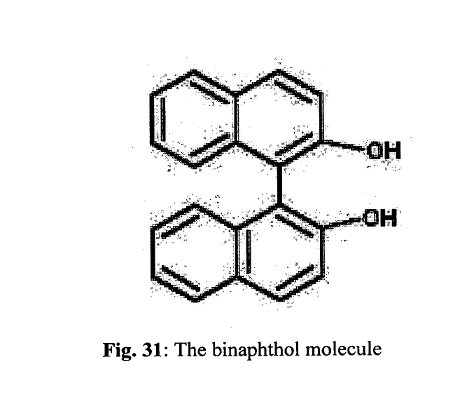

Similarly, binapthol (see FIG. 31), which was unretained on the polypropylene treated material, was now retained slightly on the C8-12 treated material. Pure mobile phase solvent went through a HPLC column packed with C8-10 treated material in 1.5 minutes, whereas binapthol (BINOL) required 1.8 minutes. Again reducing the polarity of the mobile phase, by reducing the proportion of water, caused an increase in retention.

Fractionation of wide BINOL peaks and retesting of fractions on a known commercial chiral HPLC column indicated chiral enrichment in the early and late fractions. In other words, the broad peaks observed for BINOL were often unresolved, heavily overlapped chiral peaks indicating chiral selectivity.

### Example 13

### HPLC Data Showing Separation of Dorzolomide Enantiomers on Material with a Silane C8/Phenylisocyanate Surface Treatment

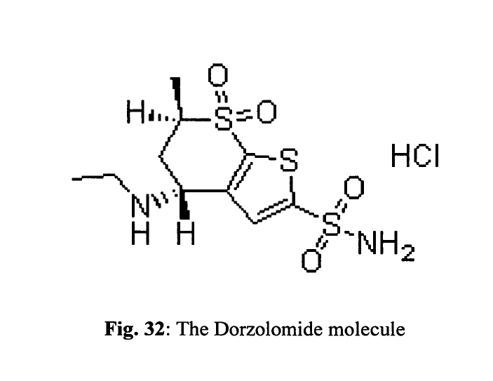

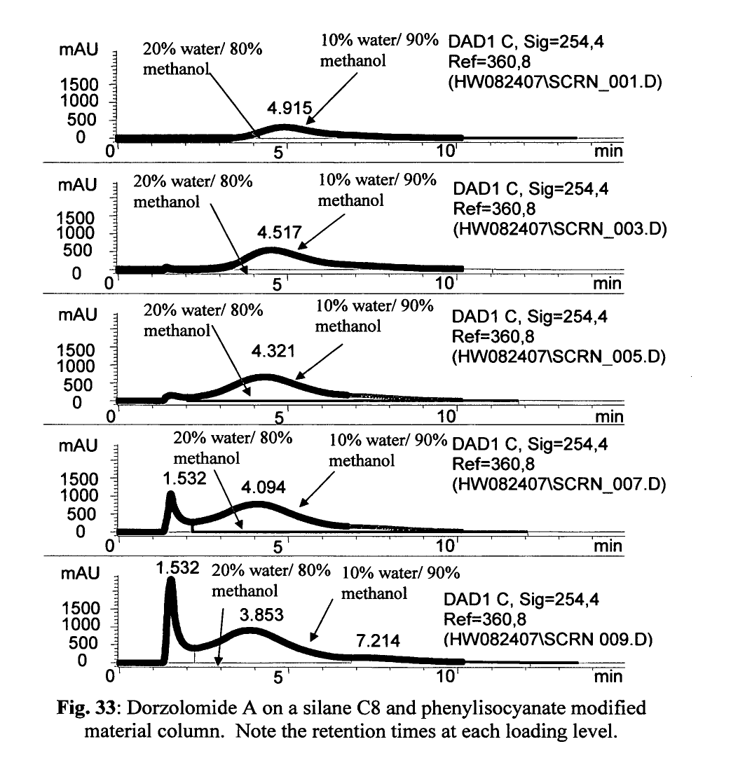

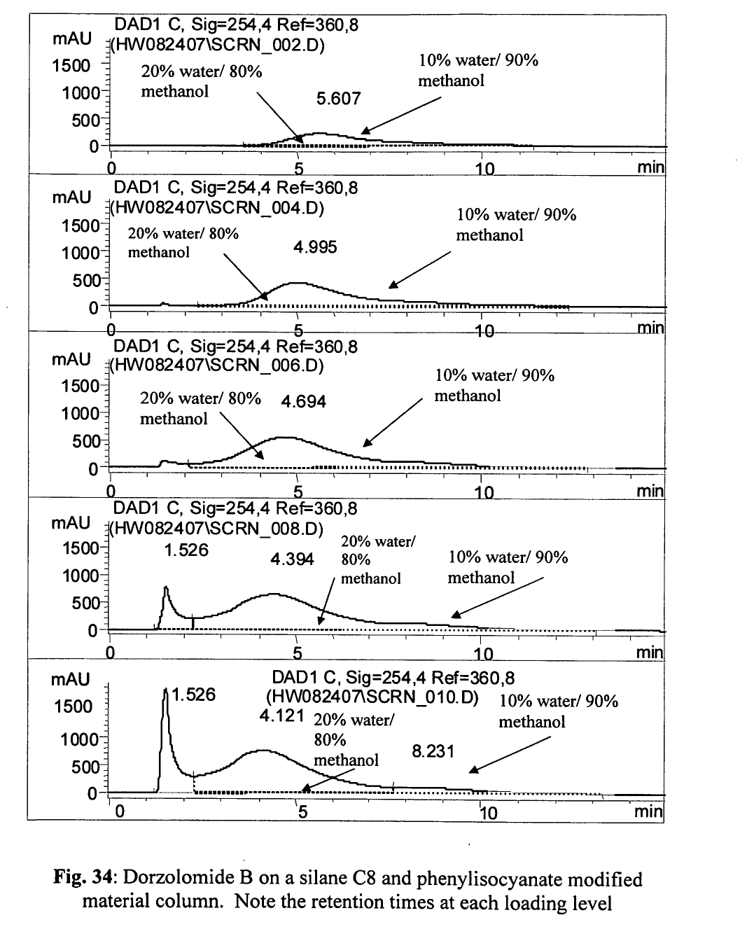

Enantiomers of dorzolomide (see FIG. 32) have significantly different retention times on a heavily modified HPLC column including isocyanate chemistry. Dorzolomide was dissolved in acetonitrile, or in 90/10 acetonitrile/methanol, and injected onto a HPLC column containing material modified with silane ligands to put C8 n-alkane chains on the material surface and phenyl isocyanate to passivate the acid groups from the biopolymer. Racemic mixtures were chirally separated under the same conditions. FIG. 33 shows the first enantiomer of dorzolomide, DorzA, under conditions of increased column loading. FIG. 34 shows the second enantiomer under the identical set of loading conditions. Note the difference in retention times under identical conditions. Dorzolomide fractions were collected from each peak in the chromatogram when a racemic mixture of dorzolomide had been injected and separated on the column. These fractions were recrystallized and checked for yield, purity, and identity. The data indicated that 90% of the enantiomers eluted off the HPLC column with good purity and the correct infrared (IR) spectra for dorzolomide.

### Modifications

It will be appreciated that still further embodiments of the present invention will be apparent to those skilled in the art in view of the present disclosure. It is to be understood that the present invention is by no means limited to the particular constructions herein disclosed and/or shown in the drawings, but also comprises any modifications or equivalents within the scope of the invention.

What is claimed is:

1. A chiral stationary phase for use in chromatographic separation, comprising:
a chiral selector compound; and
a chiral support material, wherein the chiral support material comprises a polymer comprising at least 30% chiral monomer of the same orientation.

2. A chiral stationary phase according to claim 1, wherein the chiral selector compound comprises a polysaccharide.

3. A chiral stationary phase according to claim 2, wherein the polysaccharide comprises at least one selected from the group consisting of an optically active cellulose ester derivative, an optically active cellulose carbamate derivative, an optically active amylose carbamate derivate, α-1,4-glucan, β-1,4-glucan, α-1,6-glucan, α-1,6-glucan, α-1,3-glucan, α-1,3-glucan, α-1,2-glucan, β-1,2-glucan, β-1,4-chitosan, β-1,4-N-acetylchitosan, β-1,4-galactan, α-1,6-galactan, α-1,2-fructan, β-2,6-fructan, β-1,4-xylan, β-1,4-mannan, α-1,6-mannan, pullulan, agarose, alginic acid, a starch, dextran, pustulan, curdlan, schizophylan, levan, cellulose, amylose, chitin and inulin.

4. A chiral stationary phase according to claim 1, wherein the chiral support material comprises one selected from the group consisting of a protein polymer, a fibrous polymer and a silk-based polymer.

5. A chiral stationary phase according to claim 4, wherein the chiral support material comprises a fibrous protein having a liquid crystalline order on a nanoscale and forming a nanoscale multilayered structure, wherein each layer of the multilayered structure comprises a molecularly oriented fibrous protein, and further wherein the multilayered structure defines an interlayer region having nanoscale chiral pores or channels.

6. A chiral stationary phase according to claim 5, wherein the interlayer region comprises a chiral nanometer-scale texture.

7. A chiral stationary phase according to claim 5, wherein the chiral support material comprises a network of pores, wherein the pores are interconnected.

8. A chiral stationary phase according to claim 5, wherein the chiral support material contains a network of interconnected pores, wherein the connections are offset in a manner that results in a tortuous path through the material, and further wherein (i) each tortuous path is biased in favor of a particular set of twists, tilts and turns, and (ii) each tortuous path is chiral, and further wherein more than about 50% of the tortuous paths through the material share the same chiral bias.

9. A chiral stationary phase according to claim 1 in which the chiral selector compound is absorbed onto an available surface of the chiral support material.

10. A chiral stationary phase according to claim 9, wherein adsorption comprises one selected from the group consisting of physical and electrostatic means.

11. A chiral stationary phase according to claim 1, wherein the chiral selector compound is linked to the chiral supporting material by at least one of the group consisting of a salt bridge formation and complexation groups bound to the selector and present on the support.

12. A chiral stationary phase according to claim 1, wherein the chiral selector compound is linked to the chiral supporting material through a covalent link.

13. A chiral stationary phase according to claim 1, wherein the chiral selector compound coats the chiral supporting material.

14. A chiral stationary phase according to claim 1, wherein the chiral selector compound substantially covers the surface of the chiral support material.

15. A chiral stationary phase according to claim 1, wherein the chiral selector compound is associated with a portion of the chiral support material, such that the chiral support material is available for interaction with an analyte.

16. A chiral stationary phase according to claim 15, wherein a portion of the chiral support material is associated with an achiral molecule so as to provide a desired surface property.

17. A separations column utilizing a chiral stationary phase comprising:
a chiral selector compound; and
a chiral support material, wherein the chiral support material comprises a polymer comprising at least 30% chiral monomer of the same chiral handedness.

18. A method of separating a sample containing a plurality of analytes, comprising:
providing a column packed with a chiral stationary phase comprising a chiral selector compound and a chiral support material, wherein the chiral support material comprises a polymer comprising at least 30% chiral monomer of the same orientation, and further wherein the chiral support material preferentially excludes one of a levorotary or dextrorotary compound from the stationary phase;
eluting the column with a first elutent to selectively elution analyte molecules of the excluded orientation, such that the excluded analyte molecules are separated and resolved based on molecular differences; and
eluting the column with a second elutent to elute the remaining analyte molecules of the opposite orientation, such that the remaining analyte molecules are separated and resolved based on molecular differences.

19. A chiral stationary phase for use in chromatographic separation, comprising:
a chiral support material comprising chiral nanostructure or materials morphologies imparting chiral selectivity to the support; and
an achiral coating.

20. A chiral stationary phase according to claim 19, wherein the achiral coating is at least one selected from the group consisting of a diglycidyl ether, citric acid, a ethoxy silane, a methoxy silane and a phenyl isocyanate.

21. A chiral stationary phase according to claim 19 wherein the achiral coating substantially covers a surface of the chiral support material.

22. A chiral stationary phase according to claim 19, wherein the achiral coating is associated with a portion of the chiral support material, such that the chiral support material is available for interaction with an analyte.
